(19) United States
(12) Patent Application Publication
(10) Pub. No.: US 2016/0239597 A1
(43) Pub. Date: Aug. 18, 2016

(54) APPARATUS AND METHOD FOR PERFORMING FINITE ELEMENT COMPUTATION

(71) Applicant: FUJITSU LIMITED, Kawasaki-shi (JP)

(72) Inventor: Koichi Shimizu, Inagi (JP)

(21) Appl. No.: 14/827,345

(22) Filed: Aug. 17, 2015

(30) Foreign Application Priority Data
Nov. 28, 2014 (JP) 2014-240758

(51) Int. Cl. G06F 17/50

(52) U.S. Cl. CPC G06F 17/5018; G06F 17/509

(57) ABSTRACT

A model is defined as a collection of nodes and elements, where each element is a region whose boundaries are defined by three or more nodes. A processor obtains a first dataset including first values calculated for different nodes or elements of the model. The processor sets a plurality of grid points addressed by coordinates of two or more orthogonal axes, and calculates second values corresponding respectively to a subset of the grid points, based on positions of the nodes or elements and the first values. The processor then stores a second dataset including the second values into the storage device. When the second dataset is read out of the storage device, the processor restores the first values corresponding to the plurality of nodes or elements, based on positions of the subset of the grid points and the second values included in the second dataset.

### CROSS-REFERENCE TO RELATED APPLICATION

This application is based upon and claims the benefit of priority of the prior Japanese Patent Application No. 2014-240758, filed on Nov. 28, 2014, the entire contents of which are incorporated herein by reference.

### FIELD

The embodiments discussed herein relate to an apparatus and method for performing finite element computation.

### BACKGROUND

As computers have become more and more powerful, the numerical analysis has been increasingly used to simulate various physical phenomena. Computer-based numerical simulation enables analysis of, for example, a spatial distribution of magnetization vectors observed when a magnet is placed in a space. The finite element method (FEM) is known as a technique for numerical analysis.

The FEM is used to numerically find approximate solutions for differential equations that are hard to solve with an analytical method. Briefly, the method subdivides a two-dimensional or three-dimensional problem space into small regions called “elements” and calculates an approximate solution of the original equations by applying, for each element, relatively simple interpolation functions (e.g., linear functions) to approximate the original equations. For example, a computer obtains an approximate solution by solving a large-scale system of linear equations with a sparse coefficient matrix. The resulting numerical values are usually associated with the elements or nodes that form the vertices of each element.

For example, a topological optimization system is proposed in the field of structural design of, for example, buildings and mechanical parts. The proposed system uses the FEM to find an optimal topological shape of a structural object. More specifically, this topological optimization system handles a unit cell that has outer edges forming its outer body and inner edges forming its inner space. The system normalizes the length of each outer edge to one and selects the length of each inner edge from among the set of 0, 0.2, 0.4, 0.6, 0.8, and 1.0, thus producing 216 kinds of meshed microscopic structures. The system then calculates a macroscopic stress-strain matrix depending on the inner edge length by using the Bezier interpolation, Lagrange interpolation, or other interpolation algorithms.

Another example is a method for simulating a mechanism of firing ink droplets in an inkjet printer. The proposed simulation method performs an FEM analysis with a quadrangular mesh model, using a hypercubic interpolation method, global interpolation method, or local linear interpolation method to update the distance in the interface between ink and air.

Yet another example is a thermal analyzer device for analyzing the temperature distribution of a physical object, such as mold dies, using a hexahedral mesh to represent the object for an FEM thermal analysis. During the analysis of temperature distribution, the proposed thermal analyzer device finds a portion that exhibits a larger thermal gradient and reduces the size of the hexahedral mesh in that portion.

See, for example, the following documents:

Japanese Laid-open Patent Publication No. 2002-189760

Japanese Laid-open Patent Publication No. 2007-280395

Japanese Laid-open Patent Publication No. 2007-293382

The result of an FEM analysis is recorded in a certain data format. For example, the result data may be organized as a collection of records each associating the identifier of an element or node with a value(s) calculated for that element or node. In the case of an FEM magnetic field analysis, each record may include the identifier of a specific element or node and the calculated value of magnetization vector at that element or node.

As discussed above, an FEM analysis produces result data records corresponding to elements or nodes constituting the model. The problem is that, if all those records are stored as-is, they would consume an enormous amount of storage space. Suppose, for example, that a cubic magnet with a side length of 1,000 nm is divided into cubic elements with a side length of 20 nm. This division produces 125,000,000 (=500×500×500) elements in the magnet model. The magnetic field analysis then outputs about 50 bytes of data for each single element, assuming that one record includes an element number and a three-dimensional magnetization vector expressed in floating-point form. The result data as a whole would amount to 6.25 gigabytes (=50 bytes×125,000,000). The calculations are repeated to observe the variation of magnetization vectors with time, further multiplying the result data size. For example, the result data would swell up to 625 gigabytes for one hundred time points of simulation.

In some physical phenomena, the gradient (variation) of field values exhibits a particular pattern in the analysis space. That is, a large gradient is only seen in a limited region while most regions have small gradients. Think of, for example, an analysis of magnetization reversal in a magnet. The result data of this analysis sometimes indicates a first region in which the magnetization vectors are oriented in one direction and a second region in which the magnetization vectors are oriented in the opposite direction to those in the first region. The first and second regions occupy the greater part of the space, and a large gradient is only seen in the boundary region between those two regions. When this is case, the amount of result data may be reduced by increasing the sampling point intervals in small-gradient regions.

As discussed above, the FEM treats a meshed model made up of elements and nodes, which are each assigned an identification number (e.g., non-negative integer). Generally, however, those elements and nodes are not necessarily arranged at regular intervals in the analysis space, unlike the mesh points in a Cartesian coordinate system. The order of their identification numbers may also be irregular in the analysis space, unlike the axis ticks in a Cartesian coordinate system. Simply removing some of the numerical records of elements or nodes is not a realistic way of reducing data, because it is difficult to subsample the records properly in small-gradient regions.

### SUMMARY

In one aspect of the embodiments, there is provided a non-transitory computer-readable medium storing a program that causes a computer to perform a procedure including: obtaining a first dataset including first values calculated for a model that includes a plurality of nodes and a plurality of elements each being a region whose boundaries are defined by three or more of the nodes, the first values corresponding respectively to the plurality of nodes or elements; calculating a plurality of grid points addressed by coordinates of two or more orthogonal axes; calculating second values corresponding respectively to a subset of the grid points, based on positions of the nodes or elements and the first values included in the first dataset; storing a second dataset including the second values into a storage device; and restoring, when the second dataset is read out of the storage device, the first values corresponding respectively to the plurality of nodes or elements, based on positions of the subset of the grid points and the second values included in the second dataset.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a finite element computing apparatus according to a first embodiment;

FIG. 2 illustrates an information processing system according to a second embodiment;

FIG. 3 is a block diagram illustrating an exemplary hardware configuration of an analyzer apparatus;

FIG. 4 illustrates an example of a mesh structure used in the finite element method;

FIG. 5 illustrates an example of distribution of magnetization vectors;

FIG. 6 illustrates an example of a grid that is established;

FIG. 7 illustrates an example of grid points whose magnetization vectors are recorded;

FIG. 8 illustrates another example of a grid that is established;

FIGS. 9A and 9B illustrate an example of how the gradient of a magnetization vector field is calculated;

FIGS. 10A and 10B illustrate an example of how to calculate a magnetization vector at a grid point;

FIGS. 11A, 11B, 11C, 12A, and 12B are a set of diagrams illustrating several examples of how a missing magnetization vector is interpolated at the time of data restoration;

FIGS. 13A and 13B illustrate an exemplary flow of FEM data compression;

FIGS. 14A and 14B illustrate an exemplary flow of FEM data restoration, in the context continued from FIGS. 13A and 13B;

FIG. 15 illustrates an example of parallel processing on a divided model;

FIG. 16 is a block diagram illustrating an example of functions provided in an analyzer apparatus and a computational node;

FIG. 17 illustrates an example of node data and element data;

FIG. 18 illustrates an example of an uncompressed FEM result dataset;

FIG. 19 illustrates an example of a compressed FEM result data set;

FIG. 20 is a flowchart illustrating an exemplary procedure of data compression;

FIG. 21 is a flowchart illustrating an exemplary procedure of data restoration; and

FIG. 22 is a flowchart illustrating an exemplary procedure of interpolation at a vacant grid point.

### DESCRIPTION OF EMBODIMENTS

Several embodiments will be described below with reference to the accompanying drawings.

### (a) First Embodiment

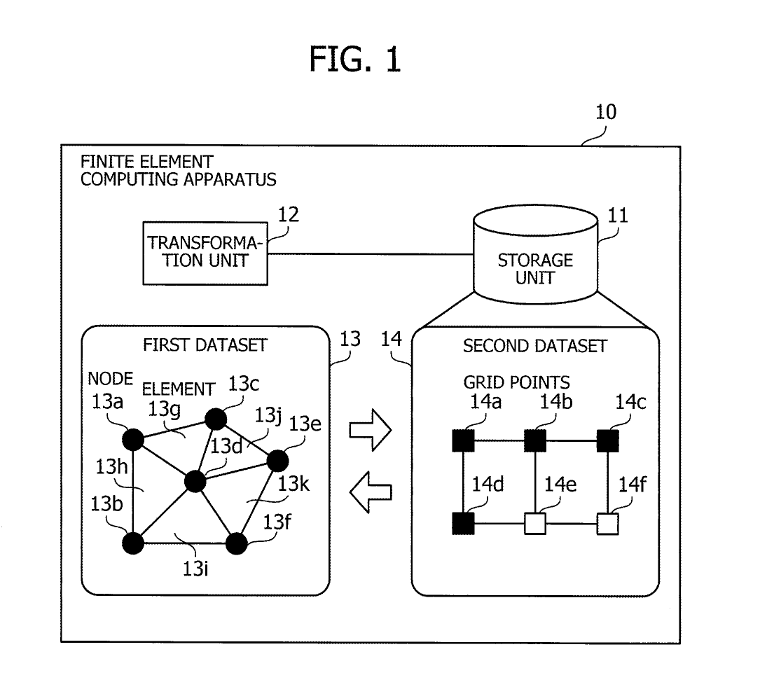

FIG. 1 illustrates a finite element computing apparatus according to a first embodiment. This finite element computing apparatus 10 performs a numerical analysis (e.g., magnetic field analysis) by using the finite element method (FEM). The FEM numerically finds an approximate solution of differential equations that are hard to solve with an analytical method.

The finite element computing apparatus 10 analyzes an object represented in the form of a two-dimensional or three-dimensional spatial model. A model is made up of a plurality of nodes and a plurality of elements. Each element represents a sub-region whose boundaries are defined by three or more nodes. For example, each element of a two-dimensional model is a triangular sub-region with three boundary-defining nodes. In the case of a three-dimensional model, each element is a tetrahedral sub-region (i.e., a solid having four triangular faces) with four boundary-defining nodes.

For example, the finite element computing apparatus 10 in FIG. 1 uses a model that includes six nodes 13a to 13f and five elements 13g to 13k. Specifically, one element 13g has its vertices at nodes 13a, 13c, and 13d. Another element 13h has its vertices at nodes 13a, 13b, and 13d. Yet another element 13i has its vertices at nodes 13b, 13d, and 13f. Likewise, still another element 13j has its vertices at nodes 13c, 13d, and 13e. Still another element 13k has its vertices at nodes 13d, 13e, and 13f. All those elements 13g to 13k are triangular sub-regions whose vertices correspond to three nodes.

The finite element computing apparatus 10 makes approximations of the original equations by using relatively simple interpolation functions, such as linear functions. The finite element computing apparatus 10 then calculates a value(s) of a specific physical quantity(ies) at each node or element. For example, what is calculated in a magnetic field analysis is magnetization vectors and potentials at different nodes or elements. Note that a value calculated for an element actually means what the physical quantity takes at the center of gravity (COG) of that element.

The finite element computing apparatus 10 includes a storage unit 11 and a transformation unit 12. The storage unit 11 is configured to store a dataset containing an FEM analysis result. The storage unit 11 may be a volatile memory device such as random access memory (RAM), or may be a non-volatile storage device such as hard disk drive (HDD) or flash memory. The transformation unit 12 is configured to transform the analysis result from one data format to another. The transformation unit may include a central processing unit (CPU), digital signal processor (DSP), or other kind of processing devices. It is also possible to use an application-specific integrated circuit (ASIC), field-programmable gate array (FPGA), or other special-purpose electronic circuits to realize the transformation unit 12. The term “processor” may be used herein to refer to a single processing device or a multiprocessor system including two or more processing devices. The processor executes a finite element computation program loaded on RAM or other memory.

The transformation unit 12 receives a first dataset 13 representing results of a finite element analysis, which includes values (e.g., magnetization vectors and potentials obtained through a magnetic field analysis) corresponding to the nodes 13a to 13f or elements 13g to 13k. The first dataset 13 seen in FIG. 1 includes result values corresponding to the individual nodes 13a to 13f as indicated by the black circles. For example, the first dataset 13 is provided as a collection of records each associating the identifier of a node with a calculated value of that node.

Upon receipt of the above first dataset 13, the transformation unit 12 calculates a plurality of grid points addressed by coordinates of two or more orthogonal axes. In the case of a two-dimensional model, the transformation unit 12 calculates grid points in a two-dimensional Cartesian coordinate system. In the case of a three-dimensional model, the transformation unit 12 calculates grid points in a three-dimensional Cartesian coordinate system. For example, FIG. 1 illustrates two-dimensional grid points 14a to 14f that the transformation unit 12 has calculated in the space where the nodes 13a to 13f and elements 13g to 13k reside. Here, the density of grid points (i.e., the number of grid points per unit area) may be smaller than the density of nodes or elements.

The transformation unit 12 then transforms the received first dataset 13 into a second dataset 14 and sends it into the storage unit 11. The produced second dataset 14 includes values (e.g., magnetization vectors and potentials obtained through a magnetic field analysis) corresponding to a subset (or at least some) of the grid points 14a to 14f. The second dataset 14 may omit some of the values corresponding to the nodes 13a to 13f and elements 13g to 13k. Referring to the example of FIG. 1, the illustrated second dataset 14 includes only four values corresponding to grid points 14a to 14d as indicated by black squares. For example, the second dataset 14 is a collection of records that associate the coordinates of four grid points 14a to 14d with their respective values.

Values at the noted grid points 14a to 14d are calculated on the basis of coordinate positions of nodes 13a to 13f and the values of those nodes 13a to 13f given in the first dataset 13. Alternatively, they are calculated on the basis of coordinate positions of elements 13g to 13k and the values of those elements 13g to 13k given in the first dataset 13. The value at a specific grid point may be estimated from known values at surrounding nodes or elements. Suppose, for example, that one grid point 14b resides in an element 13g. In this case, the value at the grid point 14b is estimated from those at nodes 13a, 13c, and 13d surrounding the element 13g.

The transformation unit 12 may skip some of the grid points 14a to 14f when compiling their values into a second dataset 14. Referring to the example of FIG. 1, the second dataset 14 contains no values for two grid points 14e and 14f as indicated by white squares. More specifically, the transformation unit 12 may be configured to omit the values at grid points when those grid points reside within an element at which the values exhibit a small gradient (e.g., in the case of a magnetic field analysis, the gradient of a magnetization vector field is small). For example, when the gradient at one element 13i is smaller than a certain threshold, and if the element 13i contains a grid point 14e, the transformation unit 12 excludes the value of that grid point 14e.

When the second dataset 14 is read out of the storage unit 11, the transformation unit 12 transforms it back into the first dataset 13. This act is referred to as “restoration” of the original dataset. To achieve the data restoration, the transformation unit 12 calculates grid points according to information that designates two or more orthogonal coordinate axes. The second dataset 14 contains values corresponding to these grid points, but not necessarily for all. When some grid point is found to lack its corresponding value, the transformation unit 12 interpolates the missing value by using known values corresponding to its surrounding grid points. Referring to the second dataset 14 seen in FIG. 1, no value is present for a grid point 14e, whereas its neighboring grid points 14b and 14d have their values. In this case, the transformation unit 12 interpolates the missing value of the grid point 14e from those at its neighboring grid points 14b and 14d. The transformation unit 12 fills other value-lacking grid points in the same way.

The transformation unit 12 now calculates values at nodes 13a to 13f or elements 13g to 13k, based on the positions and values (both the recorded and interpolated ones) of the grid points 14a to 14f. The value at a specific grid point or element may be estimated from known values at surrounding grid points. Suppose, for example, that a node 13d is surrounded by four grid points 14b, 14c, 14e, and 14f. The value at the node 13d can then be estimated from known values at those grid points 14b, 14c, 14e, and 14f.

In operation of the first embodiment described above, the proposed finite element computing apparatus 10 estimates values at grid points in a Cartesian coordinate system, when the result of a finite element analysis is obtained as a first dataset 13 of values corresponding to each node or element of the analyzed model. The original first dataset 13 is thus transformed into a second dataset containing the grid points and their corresponding values, and this second dataset 14 is sent to the storage unit 11. When the analysis result is needed, the finite element computing apparatus 10 reads out the stored second dataset 14 and restores the original first dataset 13 by estimating values at nodes or elements on the basis of those at grid points.

The above features of the finite element computing apparatus 10 make it possible to downsize the data that consumes a space in the storage unit 11 to retain analysis results. This is achieved by, for example, reducing the density of grid points on the model as compared with the density of nodes or elements in the model. Specifically, the result data of an analysis is properly compressed by subsampling grid points with a larger interval when those grid points belong to a region in which the values exhibit a relatively small gradient, or less variations.

The finite element method operates on a model made up of elements and nodes, which are each assigned an identification number (e.g., non-negative integer). Generally speaking, those elements and nodes are not necessarily arranged in a regular fashion in the analysis space, unlike the mesh points in a Cartesian coordinate system. In addition, the element and nodes are not necessarily numbered in an orderly fashion, unlike the axis ticks of a Cartesian coordinate system. For these reasons, it is difficult to remove some values directly and properly from those of the nodes or elements arranged as such. The proposed finite element computing apparatus overcomes this difficulty by calculating values at regular grid points from the original values at nodes or elements. This transformation from node-based or element-based data to grid-based data makes it easier to reduce the number of values in a region with a small gradient and thus achieves downsizing of the result dataset of analysis.

### (b) Second Embodiment

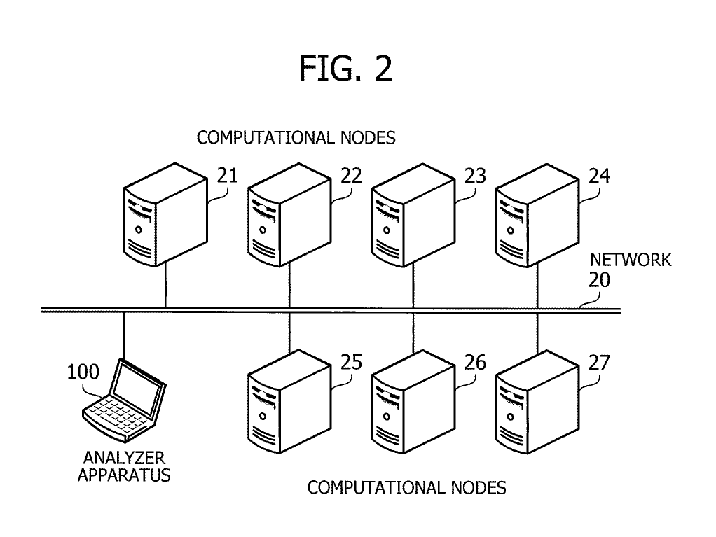

FIG. 2 illustrates an information processing system according to a second embodiment. The illustrated information processing system includes a plurality of computational nodes 21 to 27 and an analyzer apparatus 100. The computational nodes 21 to 27 are connected to a network 20, and so is the analyzer apparatus 100. The network 20 may be, for example, a local area network (LAN) or a wide area network, such as the Internet, or a combination of them.

The computational nodes 21 to 27 are server computers designed to execute specified calculations in a parallel fashion under the control of the analyzer apparatus 100. The computational nodes 21 to 27 are used to solve a large-scale problem (e.g., magnetic field analysis) in the scientific and technological fields. The following description assumes that the illustrated system is used to simulate a spatial distribution of magnetization vectors that is produced by a magnet placed in a given space. The computational nodes 21 to 27 receive program files and input data files from the analyzer apparatus 100 and store the received files in their HDDs or other local storage devices. The computational nodes 21 to 27 execute programs and produce a data file in their local storage devices to store their respective result datasets. When there is a request from the analyzer apparatus 100, the computational nodes 21 to 27 read out the result files and send them to the analyzer apparatus 100.

The analyzer apparatus 100 is a client computer or another server computer in the system, which is configured to control parallel processing in the computational nodes 21 to 27 according to commands from the user and return the calculation results to the user. Specifically, the user provides the analyzer apparatus 100 with program files and input data files for a specific computational problem. The analyzer apparatus 100 divides the given problem into a plurality of subproblems that are suitable for parallel processing and assigns them to the computational nodes 21 to 27. In the present context of magnetic field analysis, the analyzer apparatus 100 divides a given spatial model into a plurality of regions and assigns different regions to different computational nodes 21 to 27.

The analyzer apparatus 100 then sends the provided program files and input data files to the relevant computational nodes 21 to 27. Here the analyzer apparatus 100 may also supply the computational nodes 21 to 27 with parameters that indicate their respective assigned regions. When the parallel computation is finished at the computational nodes 21 to 27, the analyzer apparatus 100 collects and merges result datasets into a single file of result data. For example, the analyzer apparatus 100 renders this result data into visual images for display on a monitor screen. For small-scale problems, the analyzer apparatus 100 may be able to solve them by itself, without delegating the tasks to the computational nodes 21 to 27.

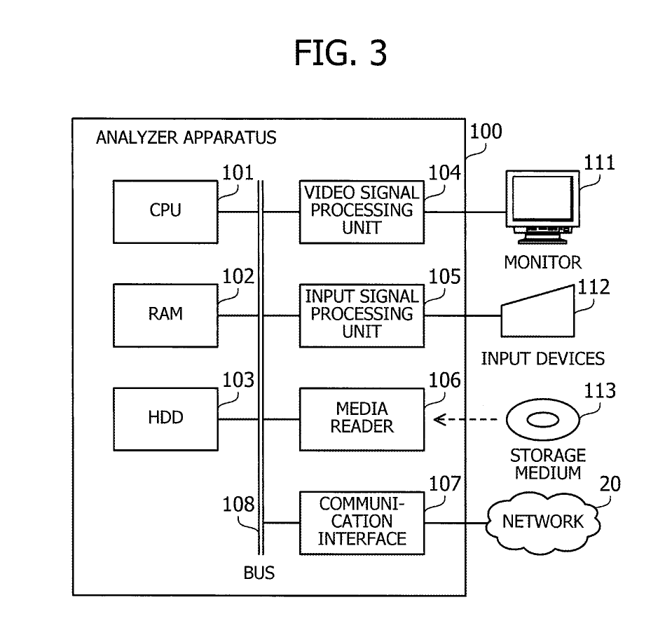

FIG. 3 is a block diagram illustrating an exemplary hardware configuration of an analyzer apparatus. The illustrated analyzer apparatus 100 includes a CPU 101, a RAM 102, an HDD 103, a video signal processing unit 104, an input signal processing unit 105, a media reader 106, and a communication interface 107. These components are each connected to a bus 108.

The CPU 101 is a processor that includes computational circuits to execute programmed instructions. The CPU 101 reads at least part of program and data files stored in the HDD 103 and executes programs after loading them on the RAM 102. The CPU 101 may include a plurality of processor cores, and the analyzer apparatus 100 may include two or more processors. These processors or processor cores may be used to execute a plurality of processing operations (described later) in parallel. The term “processor” may be used to refer to a single processing device or a multiprocessor system including two or more processing devices.

The RAM 102 is a volatile semiconductor memory device that temporarily stores programs that the CPU 101 executes, as well as for various data objects that the CPU 101 manipulates in the course of computation. Other type of memory devices may be used in place of or together with the RAM 102, and the analyzer apparatus 100 may have two or more sets of such memory devices.

The HDD 103 serves as a non-volatile storage device to store program and data files of the operating system (OS), middleware, applications, and other kinds of software. The proposed finite element computation program is one of those programs stored in the HDD 103. The analyzer apparatus 100 may include a plurality of non-volatile storage devices such as flash memories and solid state drives (SSD) in place of, or together with the HDD 103.

The video signal processing unit 104 produces video images in accordance with commands from the CPU 101 and outputs them on the screen of a monitor 111 coupled to the analyzer apparatus 100. The monitor 111 may be, for example, a cathode ray tube (CRT) display, liquid crystal display (LCD), plasma display panel (PDP), organic electro-luminescence (OEL) display, or other display device.

The input signal processing unit 105 receives input signals from input devices 112 and supplies them to the CPU 101. The input devices 112 include pointing devices (e.g., mouse, touchscreen, touchpad, trackball), keyboards, remote controllers, push button switches, and the like. The analyzer apparatus 100 allows connection of two or more input devices of different categories.

The media reader 106 is a device used to read programs and data stored in a storage medium 113. The storage media 113 include, for example, magnetic disk media such as flexible disk (FD) and HDD, optical disc media such as compact disc (CD) and digital versatile disc (DVD), magneto-optical discs (MO), and semiconductor memory devices. The media reader 106 transfers programs and data read out of such a storage medium 113 to, for example, the RAM 102 or HDD 103.

The communication interface 107 is connected to a network 20 for communication with remote computational nodes 21 to 27. The communication interface 107 may be designed for a wired network or a wireless network (or both). In the former case, the analyzer apparatus 100 is connected to a network device (e.g., switch) via a cable. In the latter case, the analyzer apparatus 100 is linked to a base station or an access point via a radio link.

The analyzer apparatus 100 may omit some of the components seen in FIG. 3. For example, the media reader 106 may be optional. The video signal processing unit 104 and input signal processing unit 105 may also be optional in the case where the analyzer apparatus 100 is implemented as a server computer. It may also be possible to integrate a monitor 111 and input devices 112 into the enclosure of the analyzer apparatus 100. While FIG. 3 illustrates the analyzer apparatus 100 alone, the same hardware configuration may be applied to the computational nodes 21 to 27 alike. It is further noted that the CPU 101 is an example of the transformation unit 12 discussed in the first embodiment, and that the RAM 102 or HDD 103 is an example of the storage unit 11 discussed in the first embodiment.

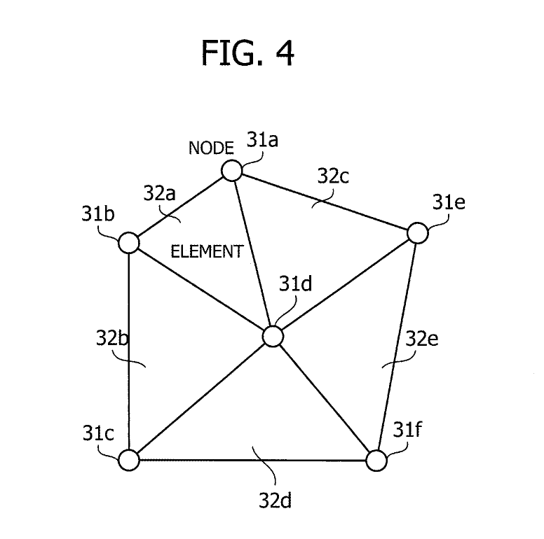

The description now discusses a magnetic field analysis using the finite element method. FIG. 4 illustrates an example of a mesh structure used in an FEM analysis. The FEM is performed on a specific model made up of a plurality of elements and a plurality of nodes. Elements are sub-regions into which the analysis space is divided, and nodes correspond to the vertices of each element. Unlike the grid points in a Cartesian coordinate system, the arrangement of nodes is not always regular. In the case of a two-dimensional model, the position of each node is designated by two-dimensional coordinates (X, Y). Element are triangular areas each formed by drawing line segments to connect three adjacent nodes. In the case of a three-dimensional model, the position of each node is designated by three-dimensional coordinates (X, Y, Z). Elements are tetrahedral regions each formed by drawing line segments to connect four adjacent nodes (tetrahedron is a solid figure having four triangular faces).

Every node is given a unique node number for the purpose of distinction, which is, but not limited to, a non-negative integer. Similarly, every node is given a unique element number for distinction, which is, but not limited to, a non-negative integer. The FEM analysis of magnetic field yields the values of magnetization vector, potential, and the like for each node or element. That is, the FEM analysis calculates these physical quantities at each particular node position or element position (i.e., COG of the element). Basically, the second embodiment is directed to the case in which magnetization vectors are calculated at tetrahedral elements or their corresponding nodes in a three-dimensional analysis space. The following description may, however, use some drawings that illustrate a two-dimensional space for simplicity purposes.

For example, FIG. 4 illustrates a two-dimensional model formed from six nodes 31a to 31f and five elements 32a to 32e. The elements 32a to 32e are triangular regions. Specifically, one element 32a has its vertices at nodes 31a, 31b, and 31d. Another element 32b has its vertices at nodes 31b, 31c, and 31d. The latter element 32b shares one side with the former element 32a. In other words, these two elements 32a and 32b are adjacent to each other. Yet another element 32c has its vertices at nodes 31a, 31d, 31e and shares one side with the element 32a mentioned above. Still another element 32d has its vertices at nodes 31c, 31d, 31f and shares one side with the element 32b mentioned above. Lastly, still another element 32e has its vertices at nodes 31d, 31e, 31f and shares one side with the element 32c, as well as another side with the element 32d.

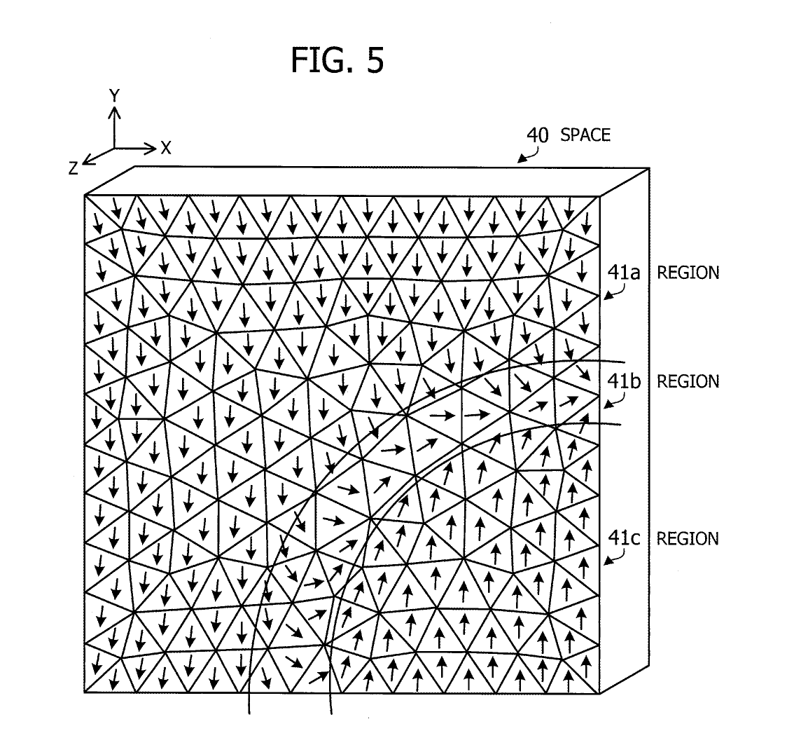

FIG. 5 illustrates an example of distribution of magnetization vectors. Each arrow in FIG. 5 represents a magnetization vector calculated at the COG of its corresponding element in the illustrated space 40. Generally, the magnetization vector distribution caused by a magnet in a space often exhibits a particular pattern of gradient. That is, large gradients are only seen in a limited region of the space, while most regions have small gradients. More specifically, there is a region in which the magnetization vectors are oriented substantially in one particular direction. There is another region in which the magnetization vectors are oriented substantially in the opposite direction to those in the former region. These two regions occupy the greater part of the space, whereas a large variation of magnetization vectors is only seen in the boundary region between the two regions.

Referring to the space 40 illustrated in FIG. 5, the magnetization vectors in one region 41a are uniformly oriented in the negative direction of Y axis, whereas those in another region 41c are uniformly oriented in the positive direction of Y axis. Yet another region 41b lies between the above two regions 41a and 41c, and its magnetization vectors exhibit a large difference between neighboring elements, meaning that the gradient is increased in this intermediate region 41b.

The magnetic field analysis, when directed to calculate a magnetization vector of each element, outputs as many result data records as the number of elements, each including an element number and a three-dimensional magnetization vector. When directed to calculate a magnetization vector of each node, the magnetic field analysis outputs as many result data records as the number of nodes, each including a node number and a three-dimensional magnetization vector. In either case, the result data records are too many to put into a single data file, because the size of such a file would grow in proportion to the number of elements or nodes in the model. Suppose, for example, that a cubic magnet with a side length of 1,000 nm is divided into cubic elements with a side length of 2 nm. This division produces 125,000,000 (=500×500×500) elements in the magnet model. The analysis then outputs 50 bytes of data for each single element, assuming that one record includes an element number and a three-dimensional magnetization vector expressed in floating-point form. After all, the result dataset of this magnetic field analysis would amount to 6.25 gigabytes (=50 bytes×125,000,000).

As discussed above, however, the spatial distribution of magnetization vectors tends to have small gradients in most regions of the space. Taking advantage of this nature, the second embodiment subsamples magnetization vectors in small-gradient regions of the analysis space, thereby compressing result data before storing them in a data file.

It has to be noted here that the elements and nodes of a model are not necessarily arranged in a regular fashion, unlike the grid points in a Cartesian coordinate system. In addition, the element and nodes are not necessarily numbered in an orderly fashion, unlike the axis ticks of a Cartesian coordinate system. Some of the magnetization vectors in small-gradient regions could be removed directly from the result data, but it is not easy to do so because of the above reasons. The second embodiment overcomes this difficulty by transforming magnetization vectors at elements or nodes into those at grid points in a Cartesian coordinate system to compress the result data of a finite element analysis. The proposed computational nodes 21 to 27 and analyzer apparatus 100 thus provide the functions of storing a result dataset in compressed form and restoring the original result dataset from the compressed data file.

The following description will discuss how a result dataset is compressed, as well as how the original result dataset is restored, assuming that the analyzer apparatus 100 plays a primary role in these procedures. Although not explicitly described, the computational nodes 21 to 27 also compress and restore datasets in a similar way.

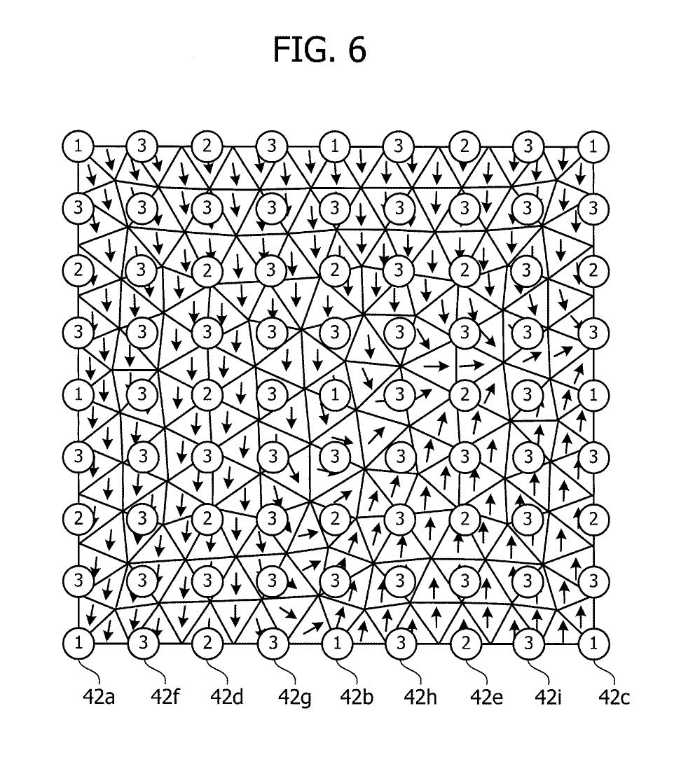

FIG. 6 illustrates an example of a grid that is established. To compress a given result dataset, the analyzer apparatus 100 places grid points in a Cartesian coordinate system representing the analysis space. For simplicity, FIG. 6 depicts grid points placed in a two-dimensional area. These grid points are classified into several layers depending on the degree of subdivision of the area, as indicated by the circled numerals.

Specifically, the grid points in FIG. 6 belong to either of Layer-1, Layer-2, and Layer-3.

The analyzer apparatus 100 begins with Layer-1 by placing multiple division points at predetermined intervals on each of the orthogonal coordinate axes (X and Y axes for two-dimensional space; X,Y, and Z axes for three-dimensional space). The analyzer apparatus 100 selects one of the division points on each axis, thereby determining one grid point. The Layer-1 grid points are established by repeating this operation for all possible divisions of axes. The analyzer apparatus 100 then halves the interval of Layer-1 division points and uses it to place finer division points for Layer-2. Similarly to Layer-1, the analyzer apparatus 100 determines a grid point by selecting one of the Layer-2 division points on each axis and repeats this operation for all possible selections. Some of the obtained grid points overlap with those of Layer-1. The analyzer apparatus 100 removes these overlapping grid points, thus finalizing the Layer-2 grid points. The analyzer apparatus 100 halves the interval of Layer-2 division points and uses it to place finer division points for Layer-3. Similarly to Layer-1 and Layer-2, the analyzer apparatus 100 determines a grid point by selecting one of the Layer-3 division points on each axis and repeats this operation for all possible selections. Some of the obtained grid points overlap with those of Layer-1 or Layer-2. The analyzer apparatus 100 removes these overlapping grid points, thus finalizing the Layer-3 grid points. The layer depth is not limited to three. Grid points may be determined for Layer-4 and subsequent layers in the same way as discussed above for Layer-1 to Layer-3.

Referring to the lowermost line of grid points in the example of FIG. 6, there are three grid points 42a, 42b, and 42c of Layer-1, and two grid points 42d and 42e of Layer-2. The former Layer-2 grid point 42d sits at the midpoint between Layer-1 grid points 42a and 42b. The latter Layer-2 grid point 42e sits at the midpoint between Layer-1 grid points 42b and 42c. Grid points 42f, 42g, 42h, and 42i belong to Layer-3. The leftmost Layer-3 grid point 42f sits at the midpoint between Layer-1 grid point 42a and Layer-2 grid point 42d. The next Layer-3 grid point 42g sits at the midpoint between Layer-2 grid point 42d and Layer-1 grid point 42b. The next Layer-3 grid point 42h sits at the midpoint between Layer-1 grid point 42b and Layer-2 grid point 42e. The rightmost Layer-3 grid point 42i sits at the midpoint between Layer-2 grid point 42e and Layer-1 grid point 42c.

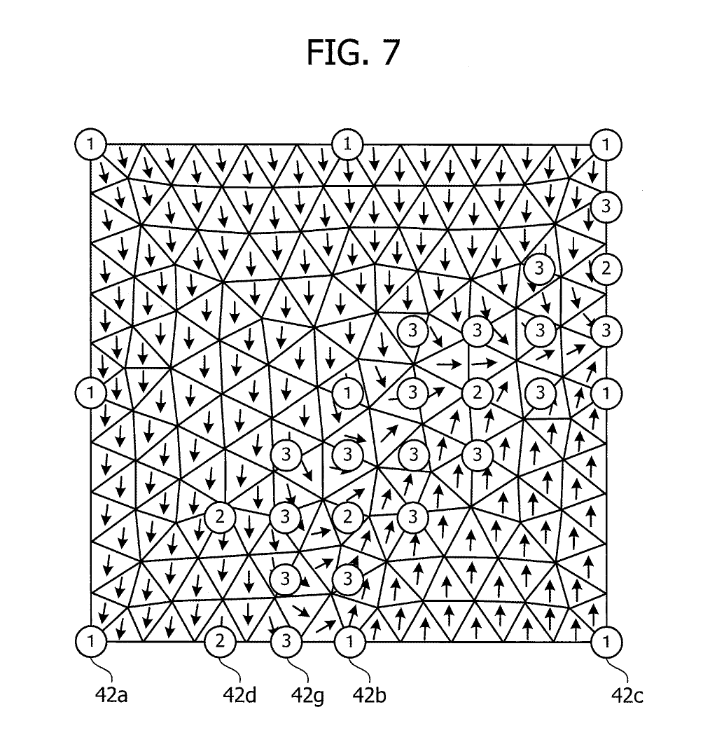

FIG. 7 illustrates an example of grid points whose magnetization vectors are recorded. The analyzer apparatus 100 records magnetization vectors, not of the elements or nodes per se, but of a subset of the grid points. In this process, the analyzer apparatus 100 disregards some of the grid points that belong to a region having small gradients, so that the resulting data file do not include magnetization vectors of those grid points.

More specifically, the analyzer apparatus 100 first selects all the Layer-1 grid points to record their magnetization vectors, no matter what gradient their corresponding regions have. The analyzer apparatus 100 then selects Layer-2 grid points to record their magnetization vectors only if the elements containing those grid points exhibit a gradient greater than a threshold determined for Layer-2. This means that no records of magnetization vectors are produced for some of the Layer-2 grid points. The analyzer apparatus 100 further selects Layer-3 grid points to record their magnetization vectors only if the elements containing those grid points exhibit a gradient greater than a threshold determined for Layer-3. This means that no records of magnetization vectors are produced for some of the Layer-3 grid points. It is noted that the analyzer apparatus 100 sets a greater threshold for Layer-3 than for Layer-2. Consequently the grid points in a deeper layer have a smaller chance of having their magnetization vectors recorded.

As a result of the above screening, the analyzer apparatus 100 has obtained a sparse distribution of grid points in a region(s) in which the magnetization vectors exhibit a small variation, as well as a dense distribution of grid points in a region(s) in which the magnetization vectors exhibit a large variation, as seen in FIG. 7. When the layer depth is desired to be four or more, the analyzer apparatus 100 assigns successively higher thresholds to Layer-4 and subsequent lower layers, similarly to the relationship between Layer-1 to Layer-3 discussed above.

Now that a final set of grid points is obtained, the analyzer apparatus 100 estimates magnetization vectors at those grid points. That is, a magnetization vector at a specific grid point may be estimated from known data of magnetization vector of an element containing the grid point, on the basis of the distance between the grid point and the COG of that element. It is also possible to estimate a magnetization vector at a grid point from known magnetization vectors of some nodes surrounding the grid point.

Referring to the example of FIG. 7, the result data file includes magnetization vectors at Layer-1 grid points 42a, 42b, and 42c regardless of the gradient in their surrounding areas. The result data file also includes a magnetization vector at a Layer-2 grid point 42d because its surrounding area exhibits a certain level of gradient. In contrast, no record of magnetization vector is produced for another Layer-2 grid point 42e (see FIG. 6) because the gradient in its surrounding area is too small to justify the use of storage resources for recording its magnetization vector. The result data file includes a magnetization vector at a Layer-3 grid point 42g because its surrounding area exhibits a sufficiently large gradient. For other Layer-3 grid points 42f, 42h, and 42i (see FIG. 6), no records are produced because the gradient in their surrounding areas is not large enough.

The analyzer apparatus 100 also has a capability of restoring the original result dataset of a finite element analysis from a file containing a compressed result dataset. Specifically, the analyzer apparatus 100 interpolates missing magnetization vectors at some grid points by using the records of magnetization vectors at their neighboring grid points. When the magnetization vectors are ready for the full set of grid points, the analyzer apparatus 100 estimates a magnetization vector at each element or node from those of its surrounding grid points, taking into consideration the distance of each surrounding grid point from the element or node in question. This procedure restores magnetization vectors corresponding to the elements or nodes.

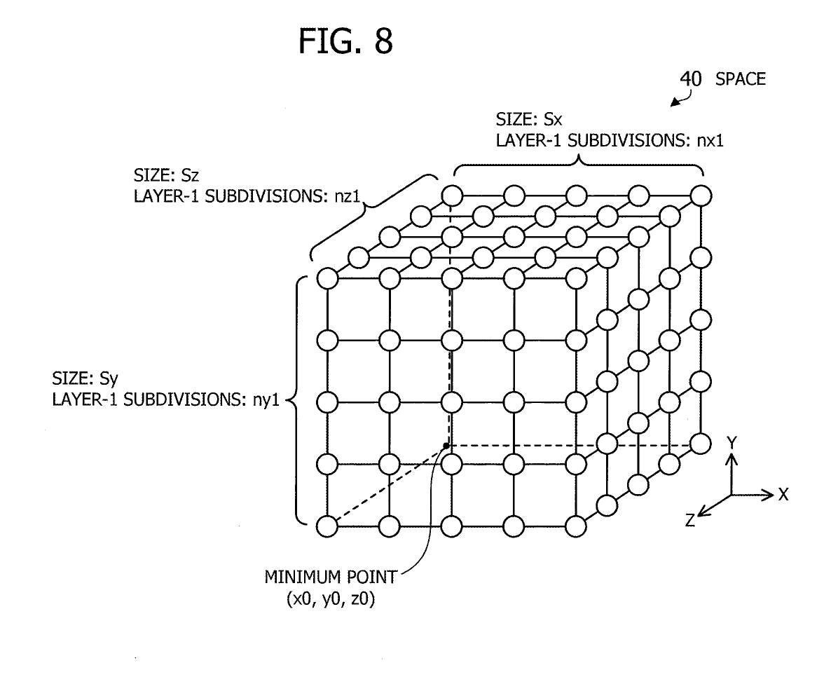

The following description will provide more detailed calculations that are performed to compress and restore the result dataset of an analysis. FIG. 8 illustrates another example of a grid that is established. As discussed above, the analyzer apparatus 100 places grid points in the analysis space in preparation for reduction of result data records. Specifically, the analyzer apparatus 100 first defines a space in the shape of a rectangular solid with an X-axis size of Sx, Y-axis size of Sy, and Z-axis size of Sz. These size parameters Sx, Sy, and Sz represent distances in the coordinate system originally used for the model of interest. These distances are different from those measured on the basis of newly assigned coordinates of grid points. As will be described later, the latter distances are expressed in terms of the number of hops between grids.

For Layer-1 grid points, the analyzer apparatus 100 determines the number (nx1) of X-axis subdivisions, the number (ny1) of Y-axis subdivisions, and the number (nz1) of Z-axis subdivisions. These subdivision numbers (nx1, ny1, nz1) may be specified by the user, or may be calculated by the analyzer apparatus 100 according to the size parameters Sx, Sy, and Sz. The rectangular solid has X-axis edges, Y-axis edges, and Z-axis edges. The X-axis edges are each divided at (nx1+1) division points into nx1 subdivisions in Layer-1. Similarly, the Y-axis edges are each divided at (ny1+1) division points into ny1 subdivisions in Layer-1, and the Z-axis edges are each divided at (nz1+1) division points into nz1 subdivisions in Layer-1, Now that division points have been established in Layer-1, those in Layer-2 and lower layers are automatically determined from the Layer-1 division points.

The analyzer apparatus 100 also determines the maximum layer depth (Nd) of grid points. Nd may be specified by the user or may be calculated by the analyzer apparatus 100 according to the size parameters Sx, Sy, and Sz. The analyzer apparatus 100 determines division points in each of the X, Y, and Z axes, from Layer-1 to Layer-Nd. Specifically, X-axis division number for Layer-Nd is (nx1×2^{Nd-1}). Y-axis division number for Layer-Nd is (ny1×2^{Nd-1}). Z-axis division number for Layer-Nd is (nz1×2^{Nd-1}). Accordingly, the X-axis edges are divided at nx (=nx1×2^{Nd-1}) division points in Layer-Nd. Y-axis edges are divided at ny (=ny1×2^{Nd-1}+1) division points in Layer-Nd. Z-axis edges are divided at nz (=nz1×2^{Nd-1}+1) division points in Layer-Nd. In this way, the analyzer apparatus 100 establishes grid points in each layer, from Layer-1 to Layer-Nd.

As mentioned above, the position of each grid point is expressed as grid coordinates in a coordinate system that is different from the spatial coordinates originally used to define the model under analysis. In the grid coordinate system, the position of a grid point is expressed as three-dimensional coordinates whose components are non-negative integers representing distances relative to the origin (0, 0, 0). Each of these integer coordinates denotes the number of “hops” from the origin. Here the “minimum point (x0, y0, z0)” is introduced to refer to the original spatial coordinates corresponding to the origin (0, 0, 0) of the grid coordinate system. Then the mapping between grid coordinates (Xn, Yn, Zn) and spatial coordinates (Xc, Yc, Zc) is expressed by the following equation (1).

$$Xc = x 0 + \frac{Sx}{nx - 1} Xn \\ Yc = y 0 + \frac{Sy}{ny - 1} Yn \\ Zc = z 0 + \frac{Sz}{nz - 1} Zn \qquad ( 1 )$$

The next part of the description discusses a method for calculating the gradient of a magnetization vector field. Also discussed is calculation of a magnetization vector at a desired point.

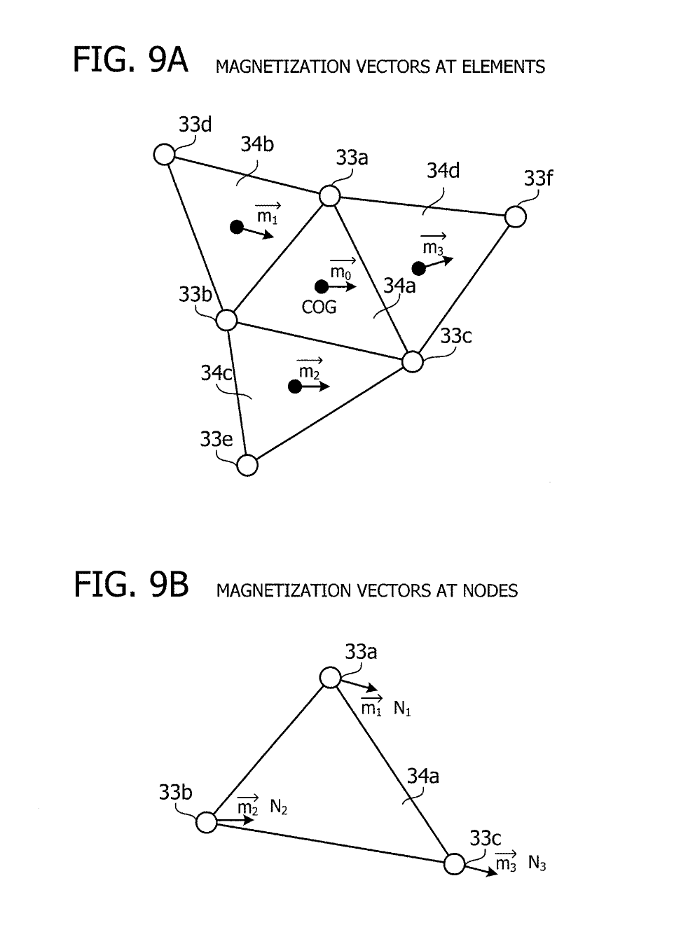

FIGS. 9A and 9B illustrate an example of how the gradient of magnetization vector field is calculated. This example assumes a model including six nodes 33a to 33f (respectively referred to as “first to sixth nodes” as needed) and four elements 34a to 34d (respectively referred to as “first to fourth elements” needed). The first element 34a has its vertices at nodes 33a, 33b, and 33c. The second element 34b has its vertices at nodes 33a, 33b, and 33d. The third element 34c has its vertices at nodes 33b, 33c, and 33e. The fourth element 34d has its vertices at nodes 33a, 33c, and 33f. As seen, the first element 34a is adjacent to the other elements 34b, 34c, and 34d. Since the elements 34a to 34d reside in a three-dimensional space, the first element 34a actually has more neighboring elements. The present description will, however, focus on the above three neighboring elements for simplicity purposes.

The finite element method is used to calculate magnetization vectors at the elements 34a to 34d as seen in FIG. 9A, or at the nodes 33a to 33f as seen in FIG. 9B. In the former case, a magnetization vector is calculated at the COG of each element 34a to 34d as indicated by the black circles. The coordinates of COG of an element are determined by averaging the coordinates of the element's vertices. That is, COG coordinates of the first element 34a are average coordinates of nodes 33a, 33b, and 33c. COG coordinates of the second element 34b are average coordinates of nodes 33a, 33b, and 33d. COG coordinates of the third element 34c are average coordinates of nodes 33b, 33c, and 33e. COG coordinates of the fourth element 34d are average coordinates of nodes 33a, 33c, and 33f.

Equation (2) below gives orthogonal components of the gradient of the magnetization vector field at the first element 34a, which is calculated from magnetization vectors at the first to fourth elements 34a to 34d.

$$\vec{∇} {m}_{x} = \frac{1}{dV} {\sum }_{i = 1}^{3} \frac{{m}_{x , 0} + {m}_{x , i}}{2} d {\vec{S}}_{i} \\ \vec{∇} {m}_{y} = \frac{1}{dV} {\sum }_{i = 1}^{3} \frac{{m}_{y , 0} + {m}_{y , i}}{2} d {\vec{S}}_{i} \\ \vec{∇} {m}_{z} = \frac{1}{dV} {\sum }_{i = 1}^{3} \frac{{m}_{z , 0} + {m}_{z , i}}{2} d {\vec{S}}_{i} \qquad ( 2 )$$

where ∇mₓ, ∇m_{y}, and ∇m_{z} respectively represent the X, Y, and Z-axis components of the gradient. The symbols in the notation of M_{axis,num} seen in the summations indicate orthogonal components of a magnetization vector calculated at each specific element. Specifically, symbols m_{x,0}, m_{y,0}, and m_{z,0} represent X, Y, and Z-axis vector components of the first element 34a. The symbols M_{x,1}, M_{y,1}, and m_{z,1} respectively represent X, Y, and Z-axis vector components of the second element 34b. Symbols m_{x,2}, m_{y,2}, and m_{z,2} represent X, Y, and Z-axis vector components of the third element 34c. Symbols m_{x,3}, m_{y,3}, and m_{z,3} respectively represent X, Y, and Z-axis vector components of the fourth element 34d. Symbol V denotes the volume of the first element 34a in question. Symbol S₁ denotes a normal vector that represents the boundary plane between the first element 34a and the second element 34b. Symbol S₂ denotes a normal vector that represents the boundary plane between the first element 34a and the third element 34c. Symbol S₃ denotes a normal vector that represents the boundary plane between the first element 34a and the fourth element 34d.

Then the gradient |∇m| of the magnetization vector field at the first element 34a is obtained as:

$$\vert \vec{∇} \vec{m} \vert = \frac{1}{dV} \sqrt{\begin{matrix}{( {\sum }_{i = 1}^{3} \frac{{m}_{x , 0} + {m}_{x , i}}{2} {dS}_{x , i} )}^{2} + {( {\sum }_{i = 1}^{3} \frac{{m}_{x , 0} + {m}_{x , i}}{2} {dS}_{y , i} )}^{2} + \\ {( {\sum }_{i = 1}^{3} \frac{{m}_{x , 0} + {m}_{x , i}}{2} {dS}_{z , i} )}^{2}\end{matrix}} + \frac{1}{dV} \sqrt{\begin{matrix}{( {\sum }_{i = 1}^{3} \frac{{m}_{y , 0} + {m}_{y , i}}{2} {dS}_{x , i} )}^{2} + {( {\sum }_{i = 1}^{3} \frac{{m}_{y , 0} + {m}_{y , i}}{2} {dS}_{y , i} )}^{2} + \\ {( {\sum }_{i = 1}^{3} \frac{{m}_{y , 0} + {m}_{y , i}}{2} {dS}_{z , i} )}^{2}\end{matrix}} + \frac{1}{dV} \sqrt{\begin{matrix}{( {\sum }_{i = 1}^{3} \frac{{m}_{z , 0} + {m}_{z , i}}{2} {dS}_{x , i} )}^{2} + {( {\sum }_{i = 1}^{3} \frac{{m}_{z , 0} + {m}_{z , i}}{2} {dS}_{y , i} )}^{2} + \\ {( {\sum }_{i = 1}^{3} \frac{{m}_{z , 0} + {m}_{z , i}}{2} {dS}_{z , i} )}^{2}\end{matrix}} \qquad ( 3 )$$

where S_{x,1}, S_{y,1}, and S_{z,1} are the X, Y, and Z-axis components of a normal vector that represents the boundary plane between the first element 34a and the second element 34b. S_{x,2}, S_{y,2}, and S_{z,2} are the X, Y, and Z-axis components of a normal vector that represents the boundary plane between the first element 34a and the third element 34c. S_{x,3}, S_{y,3}, and S_{z,3} are the X, Y, and Z-axis components of a normal vector that represents the boundary plane between the first element 34a and the fourth element 34d.

As mentioned above, the finite element method may calculate magnetization vectors at the nodes 33a to 33f. When this is the case (as in FIG. 9B), the following equation (4) gives a magnetization vector m at the COG of the first element 34a.

$$\vec{m} = {\sum }_{i = 1}^{3} {\vec{m}}_{i} {N}_{i} ( x , y , z ) \qquad ( 4 )$$

where m₁ represents the magnetization vector at the first node 33a, m₂ represents that at the second node 33b, and m₃ represents that at the third node 33c. Symbol N represents interpolation functions that work with three-dimensional coordinates as their input (arguments). Specifically, a function N₁ gives a specific weight to the magnetization vector of the ith node concerned. Interpolation function N₁ is used for the first node 33a, N₂ is for the second node 33b, and N₃ is used for the third node 33c.

Then the gradient |∇m| of the magnetization vector field at the first element 34a is obtained as:

$$\vert \vec{∇} \vec{m} \vert = \sqrt{{( {\sum }_{i = 1}^{3} {m}_{x , i} \frac{\partial {N}_{i}}{\partial x} )}^{2} + {( {\sum }_{i = 1}^{3} {m}_{x , i} \frac{\partial {N}_{i}}{\partial y} )}^{2} + {( {\sum }_{i = 1}^{3} {m}_{x , i} \frac{\partial {N}_{i}}{\partial z} )}^{2}} + \sqrt{{( {\sum }_{i = 1}^{3} {m}_{y , i} \frac{\partial {N}_{i}}{\partial x} )}^{2} + {( {\sum }_{i = 1}^{3} {m}_{y , i} \frac{\partial {N}_{i}}{\partial y} )}^{2} + {( {\sum }_{i = 1}^{3} {m}_{y , i} \frac{\partial {N}_{i}}{\partial z} )}^{2}} + \sqrt{{( {\sum }_{i = 1}^{3} {m}_{z , i} \frac{\partial {N}_{i}}{\partial x} )}^{2} + {( {\sum }_{i = 1}^{3} {m}_{z , i} \frac{\partial {N}_{i}}{\partial y} )}^{2} + {( {\sum }_{i = 1}^{3} {m}_{z , i} \frac{\partial {N}_{i}}{\partial z} )}^{2}} \qquad ( 5 )$$

where the symbols m_{x,1}, m_{y,1}, and m_{z,1} respectively represent X, Y, and Z-axis components of the magnetization vector at the first node 33a. Similarly, the symbols m_{x,2}, m_{y,2}, and m_{z,2} respectively represent X, Y, and Z-axis components of the magnetization vector at the second node 33b. The symbols m_{x,3}, m_{y,3}, and m_{z,3} respectively represent X, Y, and Z-axis components of the magnetization vector at the third node 33c.

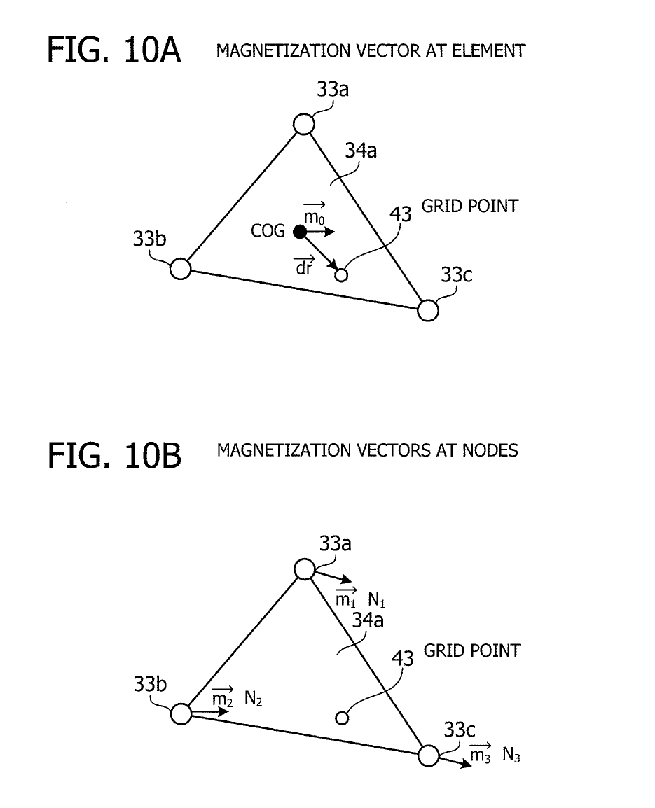

FIGS. 10A and 10B illustrate an example of how to calculate a magnetization vector at a grid point. The illustrated element 34a has its vertices at nodes 33a, 33b, and 33c (referred to as “first to third nodes”), and a grid point 43 is located within the element 34a. As noted previously, the finite element method produces a magnetization vector at the element 34a as seen in FIG. 10A, or at each node 33a to 33c as seen in FIG. 10B. In the former case, the magnetization vector m(x, y, z) at the grid point 43 is calculated according to the following equation (6).

\vec{m}(x,y,z)=\vec{m}₀+(\vec{d}r·\vec{∇})\vec{m} (6)

where vector m₀ is a magnetization vector at the COG of the element 34a. Vector dr is a position vector indicating where the grid point 43 is located relative to the COG. Symbol ∇m represents the gradient of the magnetization vector field at the element 34a, which is calculated by using, for example, equations (2) and (3) discussed above.

In the case where magnetization vectors are known at the nodes 33a, 33b, and 33c, the magnetization vector m(x, y, z) at the grid point 43 is calculated according to the following equation (7).

$$\vec{m} ( x , y , z ) = {\sum }_{i = 1}^{n} {\vec{m}}_{i} {N}_{i} ( x , y , z ) \qquad ( 7 )$$

where the coordinates (x, y, z) indicate where the grid point 43 is. Vectors m₁, m₂, and m₃ are magnetization vectors at the first node 33a, second node 33b, and third node 33c, respectively. Symbol N₁ represents interpolation functions. Specifically, interpolation function N₁ is used for the first node 33a, N₂ is for the second node 33b, and N₃ is used for the third node 33c.

The next part of the description explains an interpolation process that estimates missing magnetization vectors at grid points from a result dataset containing magnetization vectors at sparse grid points as seen in FIG. 7.

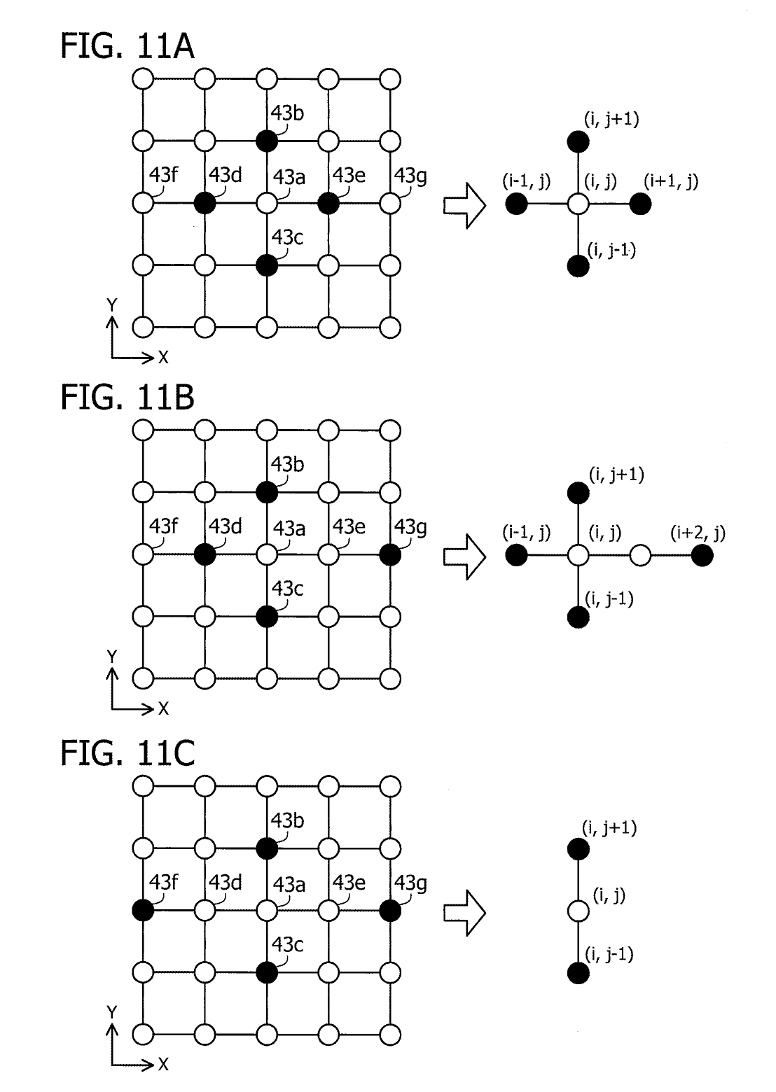

FIGS. 11A, 11B, and 11C illustrate an example of how a missing magnetization vector is interpolated at the time of data restoration. When the compressed result dataset contains no record of magnetization vector for a certain grid point, the analyzer apparatus 100 interpolates the missing magnetization vector from known magnetization vectors at other grid points surrounding the grid point in question. Specifically, the interpolation process follows four rules described below. The following explanation uses the term “vacant grid point” to refer to a grid point that has no record of magnetization vector, and the term “neighboring grid point” to refer to a grid point that has a known magnetization vector and is located in the vicinity of the vacant grid point in question.

Rule (1): The analyzer apparatus 100 seeks one neighboring grid point from the vacant grid point in both the positive and negative directions of each of the X, Y, Z coordinate axes. Neighboring grid points may have different distances from the vacant grid point in question. The analyzer apparatus 100 identifies which neighboring grid points have the minimum distance, and qualifies them as “nearest” neighboring grid points. When every axis has a neighboring grid point qualified as “nearest,” and only when every axis has a pair of neighboring grid points, one in the positive direction and the other in the negative direction relative to the vacant grid point (thus referred to as a “positive-negative pair”), the analyzer apparatus 100 interpolates the missing magnetization vector at the vacant grid point by using known magnetization vectors of the positive-negative pair of neighboring grid points on one coordinate axis. When the two neighboring grid points that form a positive-negative pair have different distances from the vacant grid point, the analyzer apparatus 100 gives different weights to their magnetization vectors according to the distances. The analyzer apparatus 100 performs this for each axis and averages the resulting interpolated magnetization vectors together.

Rule (2): When nearest neighboring grid points are found, not on all axes, but on some of the axes, and only if those axes have a positive-negative pair of neighboring grid points, the analyzer apparatus 100 uses known magnetization vectors of the positive-negative pairs of those axes to interpolate the missing magnetization vector at the vacant grid point. When two neighboring grid points that form a positive-negative pair have different distances relative to the vacant grid point, the analyzer apparatus 100 gives different weights to their magnetization vectors according to the distances. Note that the above wording “some of the axes” includes the case of one axis. When there are two such axes, the analyzer apparatus 100 performs interpolation with each positive-negative pair and averages the resulting interpolated magnetization vectors.

Rule (3): When a neighboring grid point is found on every coordinate axis but none of them forms a positive-negative pair, the analyzer apparatus 100 averages the known magnetization vectors of those neighboring grid points.

Rule (4): This rule applies when the coordinate axes found to have a neighboring grid point(s) include both of the following two types: (a) axis having only one neighboring grid point either in the positive direction or in the negative direction with respect to the vacant grid point in question; and (b) axis having two neighboring grid points qualified as a positive-negative pair. When this is the case, the analyzer apparatus 100 only uses the neighboring grid points on the latter type (b) of axes to interpolate the missing magnetization vector. When two neighboring grid points that form a positive-negative pair have different distances from the vacant grid point, the analyzer apparatus 100 gives different weights to their magnetization vectors according to the distances. Further, when two or more positive-negative pairs are present, the analyzer apparatus 100 performs interpolation with each of those pairs and averages the resulting interpolated magnetization vectors together. One exception is that, when the only neighboring grid point on an axis of the former type (a) is closer to the vacant grid point than any neighboring grid points on the other axes, the analyzer apparatus 100 uses the magnetization vector of that only neighboring grid point as an interpolated value. Further, when there are two or more type (a) axes, the analyzer apparatus 100 averages their interpolated values.

As an example, suppose that first to seventh grid points 43a to 43g, among others, are placed in a two-dimensional model as seen in FIG. 11A to 11C. Specifically, the first grid point 43a is placed at the grid coordinates of (i, j). The second grid point 43b is placed at (i, j+1), the third grid point 43c at (i, j−1), the fourth grid point 43d at (i−1, j), the fifth grid point 43e at (i+1, j), the sixth grid point 43f at (i−2, j), and the seventh grid point 43g at (i+2, j). Since the first grid point 43a is a vacant grid point (i.e., the result dataset has no record of magnetization vector for that point), the analyzer apparatus 100 interpolates this missing magnetization vector from known magnetization vectors at other grid points.

FIG. 11A illustrates the case in which four grid points 43b, 43c, 43d, and 43e have their respective magnetization vectors as indicated by black circles. All these grid points 43b, 43c, 43d, and 43e are qualified as nearest neighboring grid points with respect to the vacant grid point 43a. In other words, the vacant grid point 43a has a nearest neighboring grid point on both the X axis and Y axis, and each two opposite neighboring grid points form a positive-negative pair. The analyzer apparatus 100 therefore applies Rule (1) discussed above to this case, thus interpolating the missing magnetization vector m_{i,j} at the first grid point 43a by using known magnetization vectors at the four grid points 43b, 43c, 43d, and 43e.

More specifically, the following Equation (8) gives the magnetization vector m_{i,j} at the vacant grid point 43a in this case.

\vec{m}_{i,j}=½(½(\vec{m}_{i,j-1}+\vec{m}_{i,j+1})+½(\vec{m}_{i-1,j}+\vec{m}_{i+1,j})) (8)

That is, the analyzer apparatus 100 obtains an interpolated value for X axis by averaging magnetization vectors at the fourth grid point 43d and fifth grid point 43e. Similarly, the analyzer apparatus 100 obtains an interpolated value for Y axis by averaging magnetization vectors at the second grid point 43b and third grid point 43c. These two interpolated values are then averaged together.

As another example, FIG. 11B illustrates the case in which four grid points 43b, 43c, 43d, and 43g have their respective magnetization vectors. Three grid points 43b, 43c, and 43d out of the four are qualified as nearest neighboring grid points with respect to the vacant grid point 43a. In this arrangement, both X axis and Y axis have nearest neighboring grid points, and the found neighboring grid points form a positive-negative pair on each axis. The analyzer apparatus 100 thus interpolates the missing magnetization vector m_{i,j} at the first grid point 43a by using known magnetization vectors at the four grid points 43b, 43c, 43d, and 43e according to Rule (1) discussed above.

More specifically, the following Equation (9) gives the magnetization vector m_{i,j} at the vacant grid point 43a in this case.

\vec{m}_{i,j}=½(½(\vec{m}_{i,j-1}+\vec{m}_{i,j+1})+⅓(2\vec{m}_{i-1,j}+\vec{m}_{i+1,j})) (9)

Since the X-axis neighboring grid points 43d and 43g are at asymmetrical positions, the analyzer apparatus 100 calculates a weighted average of their magnetization vectors, giving a greater weight for a longer distance. The distance ratio between the grid points 43d and 43g is 1:2 in the example of FIG. 11B, and Equation (9) weighs their magnetization vectors at the ratio of 2:1. The analyzer apparatus 100 also interpolates a magnetization vector at the vacant grid point 43a by averaging known magnetization vectors at the grid points 43b and 43c on the Y axis. The resulting interpolated values of X-axis and Y-axis are then averaged together.

As yet another example, FIG. 11C illustrates the case in which four grid points 43b, 43c, 43f, and 43g have their respective magnetization vectors. Two grid points 43b and 43c out of the four are qualified as nearest neighboring grid points with respect to the vacant grid point 43a. In this arrangement, only Y axis has nearest neighboring grid points, and these grid points form a positive-negative pair. The analyzer apparatus 100 thus interpolates the missing magnetization vector m_{i,j} at the first grid point 43a by using known magnetization vectors of the noted grid points 43b and 43c according to Rule (2) discussed above. More specifically, the following Equation (10) interpolates the magnetization vector by averaging the two known magnetization vectors together.

\vec{m}_{i,j}=½(\vec{m}_{i,j-1}+\vec{m}_{i,j+1}) (10)

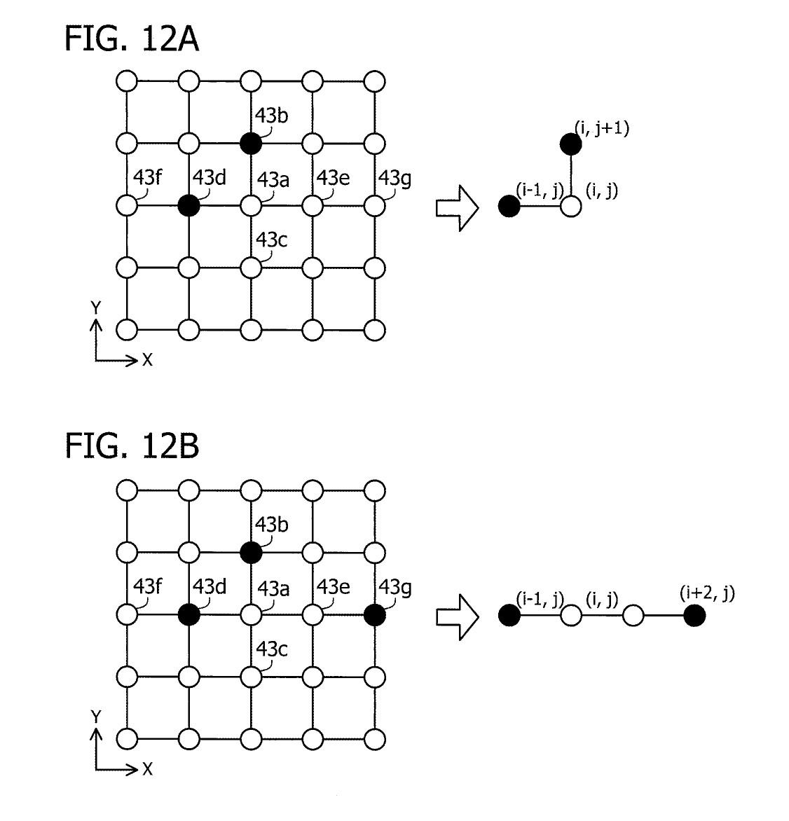

FIGS. 12A and 12B provide more examples of interpolation of magnetization vectors, continued from FIG. 11C. FIG. 12A illustrates the case in which two grid points 43b and 43d have their neighboring magnetization vectors. These grid points 43b and 43d are qualified as nearest neighboring grid points with respect to the vacant grid point 43a. In this arrangement, both X axis and Y axis have a nearest neighboring grid point, but neither of them has a positive-negative pair. Accordingly, the analyzer apparatus 100 interpolates the missing magnetization vector m_{i,j} at the first grid point 43a by using known magnetization vectors of the two grid points 43b and 43d according to Rule (3) discussed above. More specifically, the following Equation (11) interpolates the magnetization vector m_{i,j} by averaging the two known magnetization vectors together.

\vec{m}_{i,j}=½(\vec{m}_{i,j-1}+\vec{m}_{i,j+1}) (11)

As still another example, FIG. 12B illustrates the case in which three grid points 43b, 43d, and 43g have their magnetization vectors. Two grid points 43b and 43d out of the three are qualified as nearest neighboring grid points with respect to the vacant grid point 43a. In this arrangement, both X axis and Y axis have a nearest neighboring grid point, but it is only Y axis that has a positive-negative pair of neighboring grid points. The analyzer apparatus 100 thus interpolates the missing magnetization vector m_{i,j} at the first grid point 43a by using known magnetization vectors at the two opposite grid points 43d and 43g according to Rule (4) discussed above. More specifically, the following Equation (12) to interpolate the magnetization vector m_{i,j}. That is, the analyzer apparatus 100 calculates a weighted average of known magnetization vectors of the grid points 43d and 43g.

\vec{m}_{i,j}=⅓(2\vec{m}_{i,j-1}+\vec{m}_{i+2,j}) (12)

The analyzer apparatus 100 fills in the missing pieces of magnetization vectors by repeating the above computation. Now that magnetization vectors are present at all grid points, the analyzer apparatus 100 calculates magnetization vectors at elements or nodes from those at the grid points with a technique known as the Lagrange interpolation.

Specifically, the magnetization vector at an element of a two-dimensional model is calculated from magnetization vectors at four grid points that form the vertices of a rectangular grid cell containing the COG of the element in question. Likewise, the magnetization vector at a node of a two-dimensional model is calculated from magnetization vectors at four grid points that form the vertices of a rectangular grid cell containing the node in question. The magnetization vector at an element of a three-dimensional model is calculated from magnetization vectors at eight grid points that that form the vertices of a rectangular-solid grid cell containing the COG of the element in question. The magnetization vector at a node of a three-dimensional model is calculated from magnetization vectors at eight grid points that form the vertices of a rectangular-solid grid cell containing the node in question.

Equation (13) below gives the magnetization vector at an element or node in a three-dimensional model.

$$\vec{m} ( x , y , z ) = \frac{1}{DxDyDz} {\sum }_{i = 1}^{8} {ξ}_{i} {η}_{i} {ζ}_{i} ( {x}_{i} - x ) ( {y}_{i} - y ) ( {z}_{i} - z ) {\vec{m}}_{i} \qquad ( 13 )$$

where spatial coordinates (x, y, z) indicate the position of the element's COG or the node per se, and m(x, y, z) represents a magnetization vector at that position. On the right side, spatial coordinates (xᵢ, yᵢ, zᵢ) indicate a grid point corresponding to a vertex of a rectangular solid containing the element's COG or the node, and symbol mᵢ represents a magnetization vector at that spatial position. Symbols Dx, Dy, and Dz respectively denote the grid-to-grid intervals in the X-axis, Y-axis, and Z-axis directions. Symbol ξᵢ denotes a variable that adjusts the sign of (xᵢ−x), which takes a value of one when (xᵢ−x) is non-negative and a value of minus one when (xᵢ−x) is negative. Symbol ηᵢ denotes a variable that adjusts the sign of (yᵢ−y), which takes a value of one when (yᵢ−y) is non-negative and a value of minus one when (yᵢ−y) is negative. Symbol denotes a variable that adjusts the sign of (zᵢ−z), which takes a value of one when (zᵢ−z) is non-negative and a value of minus one when (zᵢ−z) is negative.

The next part of the description will discuss how the result of an FEM analysis is compressed and restored.

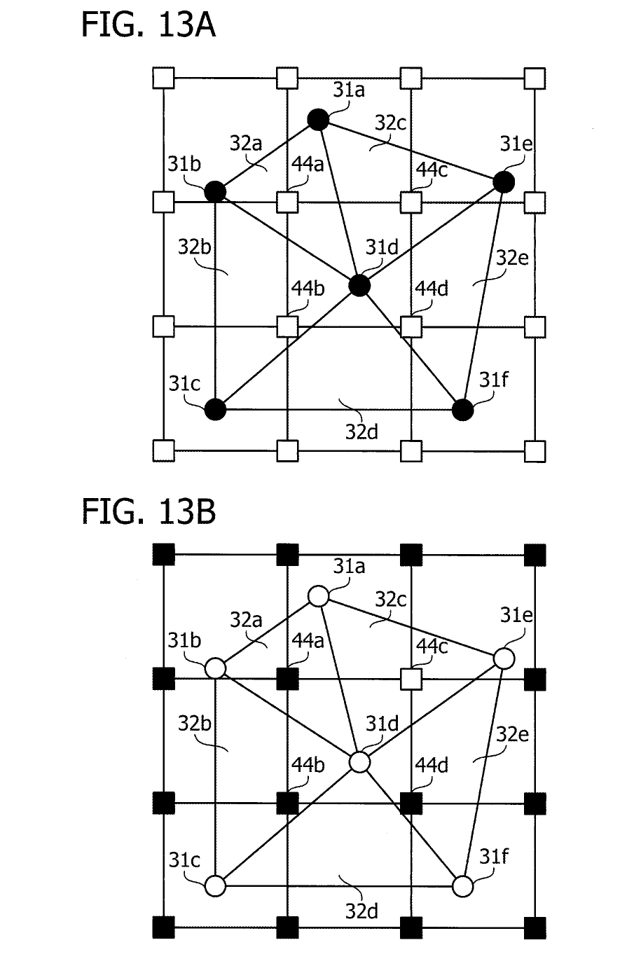

FIGS. 13A and 13B illustrate an exemplary flow of FEM data compression. FIGS. 13A and 13B include a two-dimensional model formed from nodes 31a to 31f and elements 32a to 32e, which has previously been discussed in FIG. 4. Suppose that magnetization vectors at nodes 31a to 31f have been calculated, as indicated by black circles in FIG. 13A, as a result of an FEM magnetic field analysis performed on that model. The analyzer apparatus 100 then overlays a Cartesian coordinate system and its grid points on the two-dimensional model, as indicated by white boxes in FIG. 13A. For example, one grid point 44a resides in one element 32a, and another grid point 44b resides in another element 32b. Yet another grid point 44c resides in yet another element 32c, and still another grid point 44d resides in still another element 32e. These grid points are classified into a plurality of layers (e.g., Layer-1, Layer-2, Layer-3) having different grid-to-grid intervals.

It is noted that four elements 32a, 32b, 32c, and 32e out of the five elements 32a to 32e contain a grid point. The analyzer apparatus 100 calculates the gradient of the magnetization vector field at these four elements. The analyzer apparatus 100 further records the magnetization vector of a grid point only if the element containing that grid point exhibits a gradient greater than a threshold determined for the layer to which the grid point belongs. When one element contains a grid point but the gradient at that element does not exceed the applied threshold, the analyzer apparatus 100 skips that grid point, without recording its magnetization vector (see FIG. 13B).

For example, the analyzer apparatus 100 calculates the gradient of the magnetization vector field at one element 32a using magnetization vectors at three nodes 31a, 31b, and 31d. When the calculated gradient is greater than a threshold, the analyzer apparatus 100 uses the magnetization vectors of those three nodes 31a, 31b, and 31d to calculate a magnetization vector for the grid point 44a. Likewise, the analyzer apparatus 100 also calculates the gradient of the magnetization vector field at another element 32b using magnetization vectors at three nodes 31b, 31c, and 31d. When the calculated gradient is greater than the threshold, the analyzer apparatus 100 uses the magnetization vectors of those three nodes 31b, 31c, and 31d to calculate a magnetization vector for the grid point 44b.

The analyzer apparatus 100 further calculates the gradient in another element 32c using magnetization vectors at three nodes 31a, 31d, and 31e. When the resulting gradient is smaller than or equal to the threshold, the analyzer apparatus 100 goes to the next grid point without recording magnetization vectors for the grid point 44c. Further calculated is the gradient at another element 32e using magnetization vectors at three nodes 31d, 31e, and 31f. When the resulting gradient is greater than the threshold, the analyzer apparatus 100 uses the magnetization vectors of those three nodes 31d, 31e, and 31f to calculate a magnetization vector for the grid point 44d. The above procedure yields a compressed set of records, including magnetization vectors at grid points 44a, 44b, and 44d, while no record is produced for the grid point 44c.

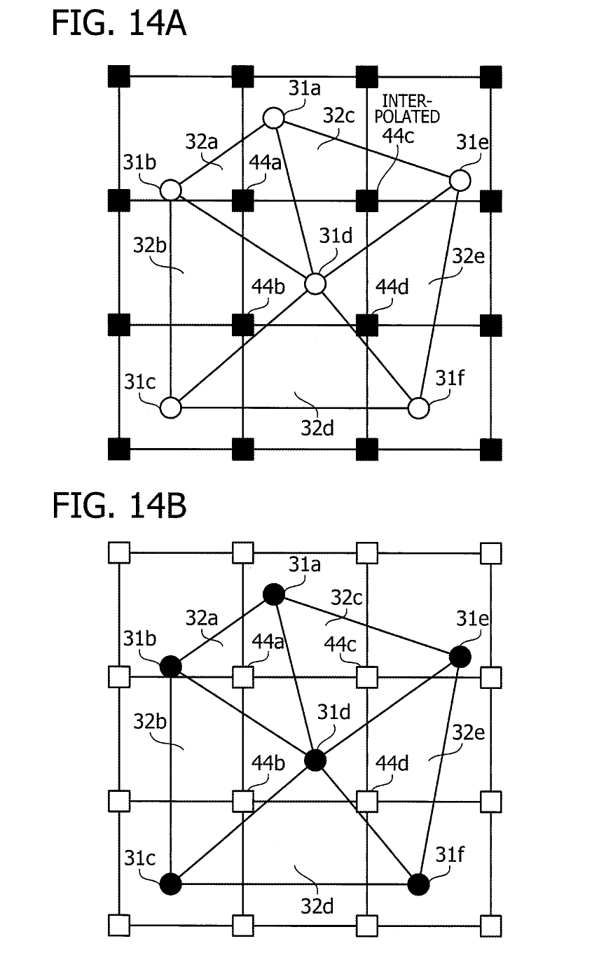

FIGS. 14A and 14B illustrate an exemplary flow of FEM data restoration, in the context continued from FIGS. 13A and 13B. The analyzer apparatus 100 restores the original result dataset from the compressed data discussed above in FIGS. 13A and 13B. This data restoration procedure begins with placing grid points of a Cartesian coordinate system on the two-dimensional model of interest. The analyzer apparatus 100 then detects grid points lacking a record of magnetization vector. The detected grid points will be treated as vacant grid points. The analyzer apparatus 100 interpolates the missing magnetization vector at each vacant grid point by using the existing records of magnetization vectors. Referring to FIG. 14A, one grid point 44c lacks a record of its magnetization vector, and the analyzer apparatus 100 thus interpolates the missing magnetization vector from known magnetization vectors at grid points 44a and 44d and other neighboring grid points.

Now that magnetization vectors are ready at all grid points, the analyzer apparatus 100 calculates magnetization vectors at nodes 31a to 31f by using those at the grid points. The magnetization vector at a node is calculated, with the Lagrange interpolation, from magnetization vectors at grid points that form the vertices of a rectangular grid cell containing the node, (see FIG. 14B). For example, the analyzer apparatus 100 calculates a magnetization vector at a node 31d by using those at grid points 44a, 44b, 44c, and 44d. The original result dataset is restored by executing this for all nodes of the model.

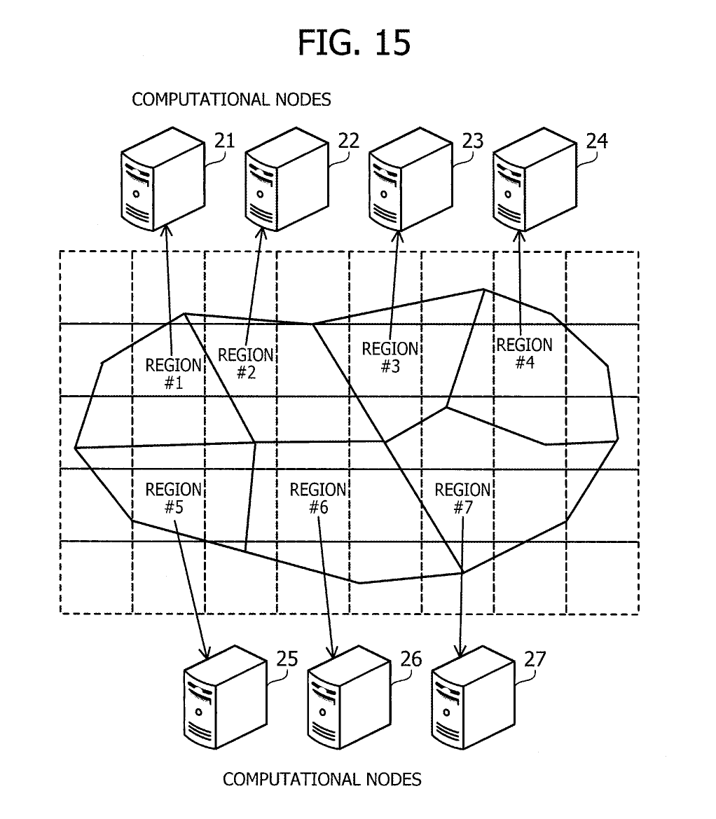

FIG. 15 illustrates an example of parallel processing on a divided model divided. A magnetic field analysis on a large-scale model may be performed as parallel processes on a plurality of computational nodes 21 to 27. When this is the case, the analyzer apparatus 100 (not illustrated) divides the model into a plurality of regions, so that the computational tasks for those regions are assigned to different computational nodes 21 to 27. Here the entire model is placed in a single spatial coordinate system. In the example of FIG. 15, the model has been divided into seven regions #1 to #7. The analyzer apparatus 100 assigns region #1 to one computational node 21 and region #2 to another computational node 22. Likewise, the analyzer apparatus 100 assigns other regions #3, #4, #5, #6, and #7 respectively to computational nodes 23, 24, 25, 26, and 27.

The analyzer apparatus 100 supplies the computational nodes 21 to 27 with data of elements and nodes constituting the model, as well as information about the assignment of regions. The computational nodes 21 to 27 concurrently execute an FEM magnetic field analysis on their assigned regions. Each computational node 21 to 27 calculates a magnetization vectors at each element or node, thus obtaining a distribution of magnetization vectors within an assigned model region. For example, one computational node 21 obtains a distribution of magnetization vectors in region #1, while another computational node 22 obtains that in region #2.

The computational nodes 21 to 27 record the result of the FEM analysis in their respective local storage devices (e.g., HDD). To compress this result dataset, the computational nodes 21 to 27 establish a common grid coordinate system accommodating the entire model. This is achieved by applying the same computational algorithm to the model. Based on the common grid coordinate system, each computational node 21 to 27 places grid points in the assigned regions and calculates and records magnetization vectors at some or all of the grid points. For example, one computational node 21 establishes a grid coordinate system accommodating the entire model and calculates magnetization vectors at grid points in region #1. Another computational node 22 also establishes a grid coordinate system equivalent to the one established by the computational node 21 and uses it to calculate magnetization vectors at grid points in region #2.

Upon completion of individual processing in the computational nodes 21 to 27, the analyzer apparatus 100 collects result datasets from them. For example, the analyzer apparatus 100 makes access to one computational node 21 to retrieve a result dataset of region #1 from its local storage device. The analyzer apparatus 100 also makes access to another computational node 22 to retrieve a result dataset of region #2 from its local storage device. What is transmitted from each computational node to 27 to the analyzer apparatus 100 is a compressed regional result dataset.

The analyzer apparatus 100 merges the received regional result datasets of the computational nodes 21 to into a single data file. Because the computational nodes 21 to 27 have used a common grid coordinate system for data compression, the analyzer apparatus 100 simply merges the received datasets without the need for extra calculations such as conversion of coordinate systems. The analyzer apparatus 100 stores this merged result dataset, still in compressed form, in its local HDD 103. The analyzer apparatus 100 restores the original FEM analysis results (i.e., magnetization vectors at elements or nodes) from the merged result dataset and displays the distribution of magnetization vectors on a monitor screen.

The above merging of regional result datasets may be optional. That is, the analyzer apparatus 100 may store the compressed result datasets of the computational nodes 21 to 27 as separate files in its HDD 103. As another option for the merging, the analyzer apparatus 100 may merge the result datasets after restoring their original content of FEM results.

The next part of the description discusses functional blocks in the proposed analyzer apparatus 100 and computational nodes 21 to 27.

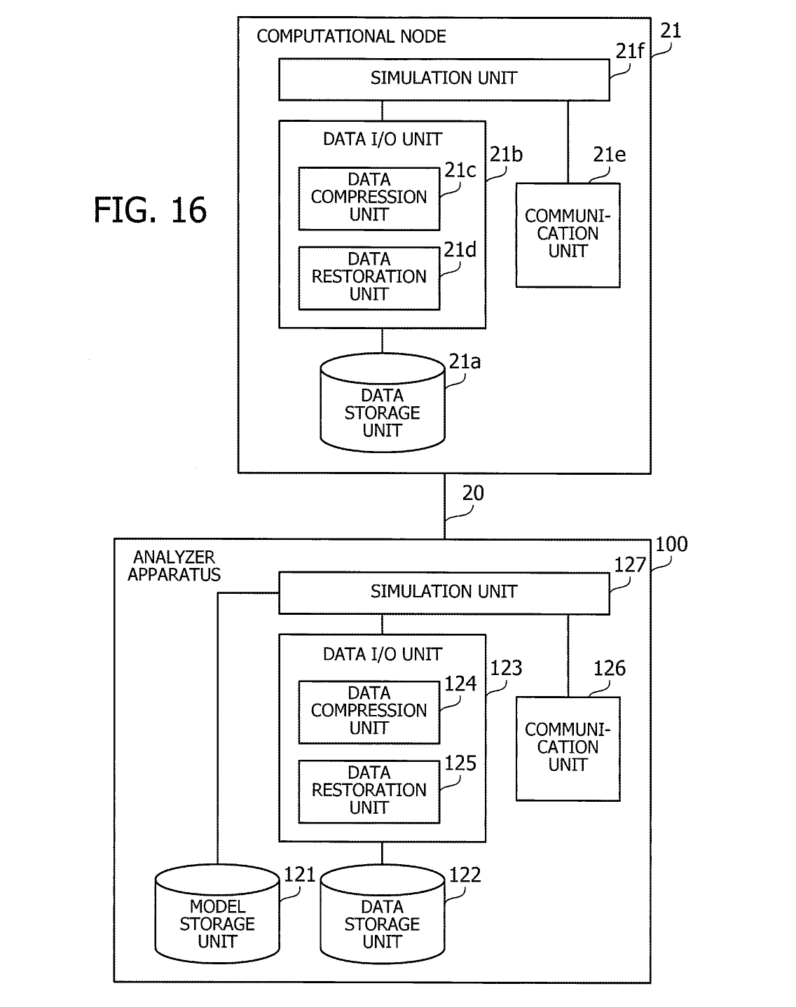

FIG. 16 is a block diagram illustrating an example of functions provided in an analyzer apparatus and a computational node. The computational node 21 seen in the upper half of FIG. 16 includes a data storage unit 21a, a data I/O unit 21b, a communication unit 21e, and a simulation unit 21f. The data storage unit 21a may be implemented as a storage space of an HDD or other storage devices integrated in or attached to the computational node 21. The data I/O unit 21b, communication unit 21e, and simulation unit 21f may be provided as program modules that the CPU in the computational node 21 executes. While not depicted, other computational nodes 22 to 27 have their own modules that work in a similar way to those in the computational node 21.

The data storage unit 21a provides a storage space for a result dataset of FEM numerical analysis. This result dataset has been compressed with the foregoing method. That is, the stored result dataset is a collection of records of magnetization vectors, not of the elements or nodes per se, but at grid points in a Cartesian coordinate system, where magnetization vectors at some grid points are not recorded to reduce the data size.

The data I/O unit 21b sends a result dataset to the data storage unit 21a, or reads a stored result dataset out of the data storage unit 21a, upon request from the simulation unit 21f. To this end, the data I/O unit 21b includes a data compression unit 21c and a data restoration unit 21d described below.

The data compression unit 21c compresses a new result dataset supplied from the simulation unit 21f before storing it in the data storage unit 21a. The data compression unit 21c establishes a Cartesian coordinate system that covers the entire model and calculates coordinates of grid points corresponding to a region of the model that is assigned to the computational node 21 (e.g., region #1 in FIG. 15). The data compression unit 21c selects grid points with a large gradient and calculates a magnetization vector at each selected grid point on the basis of existing magnetization vectors at elements or nodes of the model. That is, the magnetization vector at a specific grid point is calculated from that at an element containing the grid point in question (as in FIG. 10A), or from those at nodes surrounding the grid point in question (as in FIG. 10B). The data compression unit 21c produces a file that contains the result dataset compressed in this way and sends it to the data storage unit 21a.

The data restoration unit 21d reads a file of a compressed result dataset out of the data storage unit 21a upon request from the simulation unit 21f. The data restoration unit 21d establishes a Cartesian coordinate system that covers the entire model and calculates coordinates of grid points corresponding to a region of the model that is assigned to the computational node 21.

The compressed result dataset lacks records of magnetization vector for some of the grid points. The data restoration unit 21d thus interpolates missing magnetization vectors at those vacant grid points on the basis of known magnetization vectors of their neighboring grid points. The data restoration unit 21d restores the original result dataset by calculating a magnetization vector at each element or node of the model on the basis of magnetization vectors at nearest grid points around the element or node in question. The data restoration unit 21d then supplies the restored result dataset to the simulation unit 21f.

The communication unit 21e communicates with the analyzer apparatus 100 vial a network 20. For example, the communication unit 21e may receive a command for an FEM numerical analysis from the analyzer apparatus 100. This command includes model data that gives elements and nodes of a specific model and assignment information that indicates a model region assigned to the computational node 21. The communication unit 21e forwards the received model data and assignment information to the simulation unit 21f. The communication unit 21e also receives a request for a result dataset from the analyzer apparatus 100. In response, the communication unit 21e interacts with the simulation unit 21f to retrieve a data file containing the requested result dataset from the data storage unit 21a and transmits the retrieved file to the analyzer apparatus 100. What is transmitted here is a compressed result dataset.

The simulation unit 21f executes an FEM numerical analysis as follows. Upon receipt of model data and assignment information, the simulation unit 21f calculates magnetization vectors at elements or nodes of a model that the received model data specifies. The model may have been divided into multiple regions for parallel simulation, and in that case, the simulation unit 21f is to calculate magnetization vectors in one of those regions that is specified by the received assignment information. The information provided from the analyzer apparatus 100 may also include the choice between elements and nodes. The simulation unit 21f passes its result dataset to the data I/O unit 21b to store it in the data storage unit 21a. The simulation unit 21f also reads a stored result dataset out of the data storage unit 21a via the data I/O unit 21b. When this is done in response to a request from the analyzer apparatus 100, the simulation unit 21f passes the compressed requested result dataset to the communication unit 21e.

Referring now to the lower half of FIG. 16, The illustrated analyzer apparatus 100 includes a model storage unit 121, a data storage unit 122, a data I/O unit 123, a communication unit 126, and a simulation unit 127. The model storage unit 121 and data storage unit 122 may be implemented as reserved storage spaces in the RAM 102 or HDD 103. The data I/O unit 123, communication unit 126, and simulation unit 127 may be implemented as program modules that the CPU 101 executes.

The model storage unit 121 stores model data that defines elements and node constituting a model to be analyzed. For example, the user has created and loaded model data in the analyzer apparatus 100. The data storage unit 122, on the other hand, provides a space for a file containing result data of an FEM numerical analysis. The analysis may have been done as a parallel process on a plurality of computational nodes 21 to 27, in which case the analyzer apparatus 100 collects regional analysis results from the computational nodes 21 to 27. The data storage unit 122 stores a merged result data file or individual result data files without merging them. In either case, the stored result data file(s) in the data storage unit 122 contains a result dataset compressed with the foregoing method.

The data I/O unit 123 sends a result dataset to the data storage unit 122, or reads a stored result dataset out of the data storage unit 122, upon request from the simulation unit 127. The data I/O unit 123 is similar to the foregoing data I/O unit 21b in terms of their functions. That is, the data I/O unit 123 similarly includes a data compression unit 124 and a data restoration unit 125 described below.

The data compression unit 124 compresses a new result dataset supplied from the simulation unit 127 before storing it in the data storage unit 122. The data compression unit 124 first establishes a Cartesian coordinate system that covers the entire model and calculates coordinates of grid points. The data compression unit 124 then compresses the result dataset and stores a file containing the compressed result dataset in the data storage unit 122.

The data restoration unit 125 reads a file of compressed result data out of the data storage unit 122 upon request from the simulation unit 127 and restores the original magnetization vector at each element or node, based on the coordinates of grid points in a Cartesian coordinate system that covers the entire model. The data restoration unit 125 then supplies the restored result dataset to the simulation unit 127.

The communication unit 126 communicates with computational nodes 21 to 27 via the network 20. For example, the communication unit 126 sends a command for an FEM numerical analysis to the computational nodes 21 to 27 when so requested by the simulation unit 127. The communication unit 126 also sends a request for a result dataset to computational nodes 21 to 27 when so commanded by the simulation unit 127. The communication unit 126 receives result data files from the computational nodes 21 to 27 and forwards them to the simulation unit 127. Each received file contains the requested result data in compressed form.

The simulation unit 127 executes an FEM numerical analysis on its own, or delegates the tasks of an FEM numerical analysis to computational nodes 21 to 27 to executes them in a parallel fashion. In the former case, the simulation unit 127 retrieves pertinent model data from the model storage unit 121 and calculates magnetization vectors at elements and nodes in the model specified by the model data. The user may specify the choice between elements and nodes. In the latter case, the simulation unit 127 divides the model into multiple regions, assigns them to the computational nodes 21 to 27, and supplies assignment information to the communication unit 126, together with the model data.

The simulation unit 127 is also capable of visualizing result data of the analysis when requested by the user. For example, the simulation unit 127 outputs a drawing on the monitor 111 that uses arrows to express magnetization vectors. The simulation unit 127 also passes a result dataset to the data I/O unit 123 to store it in the data storage unit 122. The simulation unit 127 further reads a stored result dataset out of the data storage unit 122 via the data I/O unit 123. Data files stored in the data storage unit 122 contain result datasets in compressed form.

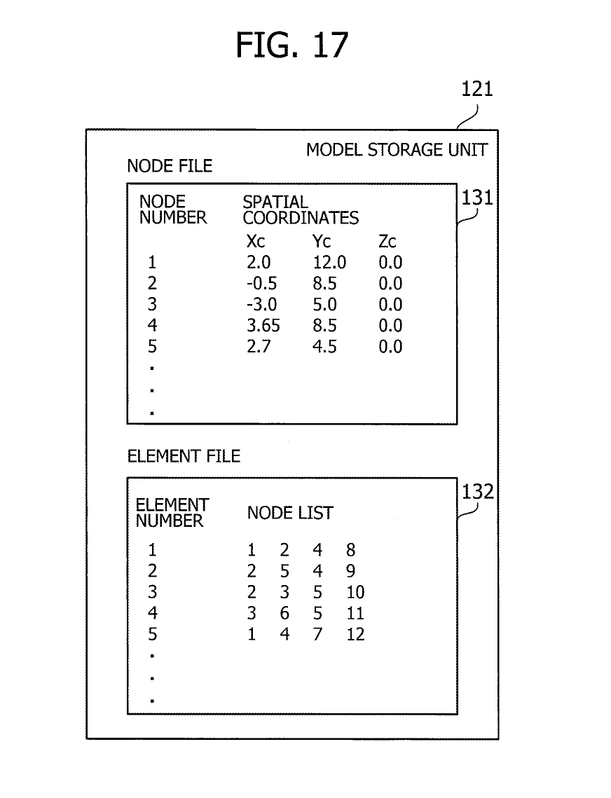

FIG. 17 illustrates an example of node data and element data. The illustrated node file 131 is stored in the model storage unit 121 (FIG. 16) and contains a plurality of records each made up of a node number and spatial coordinates (Xc, Yc, Zc), where one combination of these values corresponds to one specific node. Node number is an identifier for distinguishing a node from others. Spatial coordinates associated with a node number indicate the position of a specific node identified by that node number. For example, the first record of the node file 131 means that a node with a node number of “1” is located at spatial coordinates (2.0, 12.0, 0.0).

Also illustrated in FIG. 17 is an element file 132 in the model storage unit 121. The element file 132 contains a plurality of records each made up of an element number and a node list, where one combination of these values corresponds to one specific element. Element number is an identifier for distinguishing an element from others. Node list is a set of node numbers that indicates which nodes form the vertices of an element. Specifically, the node list contains three node numbers in the case of two-dimensional models. For three-dimensional models, the node list contains four node numbers. For example, the first record of the illustrated element file 132 includes an element number “1” and a node list enumerating four node numbers “1,” “2,” “4” and “8.” This indicates that the numbered element “1” is a tetrahedral sub-region whose vertices are located at four nodes respectively numbered “1,” “2,” “4” and “8.”

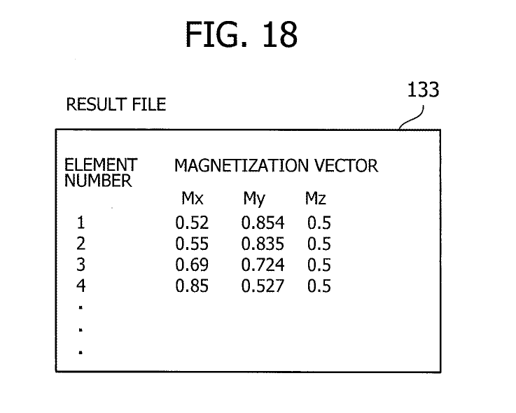

FIG. 18 illustrates an example of an uncompressed FEM result dataset. The illustrated result file 133 contains an uncompressed result dataset. This is what the simulation unit 127 has produced as an output of an FEM analysis by calculating a magnetization vector at each element of a three-dimensional model. The result file 133 contains a plurality of records each made up of an element number and a magnetization vector (Mx, My, Mz), where one combination of these values corresponds to one specific element. In the case where the result file 133 is produced from magnetization vectors at nodes of the model, the element numbers are replaced by node numbers. The magnetization vectors seen in the result file 133 are spatial vectors defined on the basis of a spatial coordinate system used to build the model. Each magnetization vector is expressed in the form of X, Y, and Z components because the model is three-dimensional in this example.

The simulation unit 21f in the computational node 21 may also produce a result dataset similarly to the simulation unit 127 in the analyzer apparatus 100. The former simulation unit 21f, however, calculates magnetization vectors only in a limited region of the model that is previously assigned to the computational node 21.

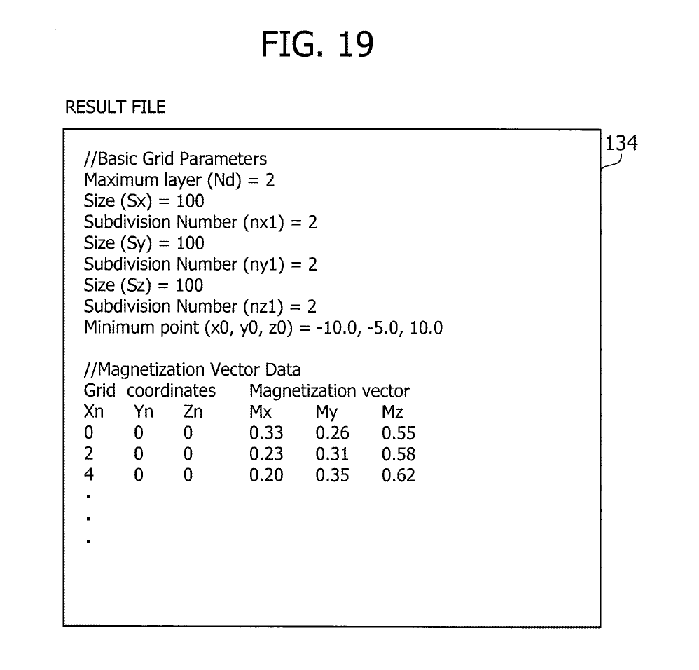

FIG. 19 illustrates an example of a compressed FEM result dataset. The illustrated result file 134 contains result data of an analysis in compressed form. The data compression unit 124 has created and stored this file in the data storage unit 122. Specifically, the result file 134 includes two sections titled “Basic grid parameters” and “Magnetization vector data.”

The Basic grid parameters section is used to reproduce grid coordinates when the data restoration unit 125 restores the original result data. More specifically, the basic grid parameters include the following values: maximum layer depth (Nd), size (Sx, Sy, Sz), subdivision numbers (nx1, ny1, nz1), and minimum point coordinates (x0, y0, z0). The maximum layer depth Nd is the maximum number of layers to which grid points belong. The size parameters Sx, Sy, and Sz respectively represent the lengths in the X-axis, Y-axis, and Z-axis direction, of a space in which grid points are established (see FIG. 8). The size parameters Sx, Sy, and Sz are defined on the basis of the spatial coordinate system of the model. The subdivision numbers nx1, ny1, and nz1 respectively indicate into what number of subdivisions the Layer-1 grid points subdivide the X-axis edge, Y-axis edge, and Z-axis edge of the model space. The minimum point coordinates (x0, y0, z0) indicate the spatial coordinate position corresponding to the origin (0, 0, 0) of the grid space.

The magnetization vector data section of the result file 134 contains a plurality of records each made up of grid coordinates (Xn, Yn, Zn) and a magnetization vector (Mx, My, Mz), where one combination of these values corresponds to one specific grid point. The grid coordinates distinguish each specific grid point from others and are expressed as the number of hops in the X-axis, Y-axis, and Z-axis directions with respect to the origin (0, 0, 0). Magnetization vectors are defined on the basis of the spatial coordinate system of the model. The result file 134 does not necessarily cover the entire set of grid points or their corresponding magnetization vectors. For example, the result file 134 in FIG. 19 covers grid coordinates (0, 0, 0), (2, 0, 0), and (4, 0, 0), but skips (1, 0, 0) and (3, 0, 0).

In the case where a numerical analysis is performed as parallel processes on a plurality of computational nodes 21 to 27, more result files similar to the above-described result file 134 are created and stored in their data storage units. These result files provide regional result datasets. For example, the computational node 21 store a result file in its local data storage unit 21a, which includes magnetization vectors at grid points only in its assigned region of the model. This is also true for the other computational nodes 22 to 27. Accordingly, the result files produced by the computational nodes 21 to 27 have different data in the magnetization vector data section, whereas the basic grid parameters section contains common values.

The next part of the description discusses procedures that the analyzer apparatus 100 executes to compress or restore a result dataset. While not explicitly disclosed, the computational nodes 21 to 27 may also execute the same procedures when it is needed.

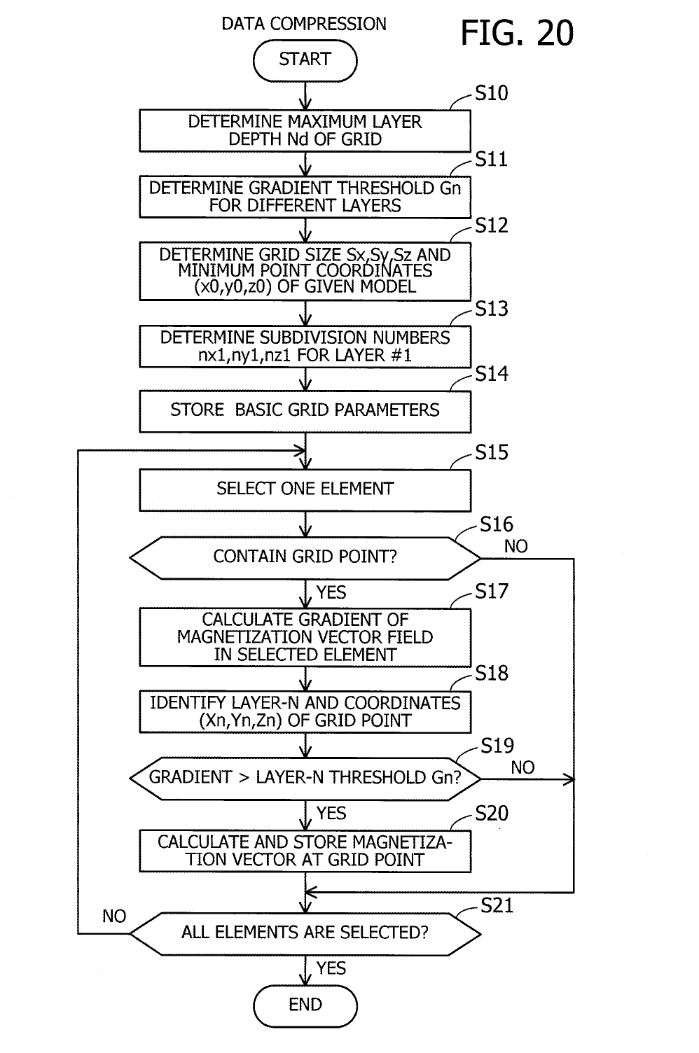

FIG. 20 is a flowchart illustrating an exemplary procedure of data compression.

(S10) The data compression unit 124 determines the maximum layer depth Nd of the grid. This Nd may previously be set as a constant value, or may be specified by the user.

(S11) The data compression unit 124 determines gradient thresholds Gn for different layers (Layer-N), where n and N are 2 to Nd. For example, successively larger gradient thresholds are selected for successively deeper layers (i.e., G₂<G₃< . . . <G_{Nd}). These gradient thresholds Gn may be determined previously as constant values.

(S12) The data compression unit 124 identifies which part of the model space has undergone the numerical analysis, and determines the size parameters Sx, Sy, and Sz that define the spatial range of grid points to be placed. The data compression unit 124 also determines minimum point coordinates (x0, y0, z0) to which the origin of the grid will be mapped.

(S13) The data compression unit 124 determines subdivision numbers nx1, ny1, and nz1 for Layer-1. These subdivision numbers may be previously determined as constant values, or may be specified by the user, or may be dynamically determined in relation to the size parameters Sx, Sy, and Sz and the like.

(S14) The data compression unit 124 produces a result file 134 and writes basic grid parameters determined above into the result file 134. Specifically, the basic grid parameters include the maximum layer depth Nd determined at step S10, size parameters Sx, Sy, and Sz and minimum point coordinates (x0, y0, z0) determined at step S12, and subdivision numbers nx1, ny1, and nz1 determined at step S13. Based on those basic grid parameters, the data compression unit 124 calculates the coordinates of grid points, from those in Layer-1 to those in Layer-Nd. Each grid point thus belongs to either of the Nd layers.

(S15) The data compression unit 124 selects one element out of the model.

(S16) The data compression unit 124 determines whether the element selected at step S15 contains at least one grid point. When the selected element contains a grid point, the process advances to step S17. When no grid point is present, the process skips to step S21.

(S17) The data compression unit 124 calculates the gradient of the magnetization vector field at the selected element. When the original result dataset gives a magnetization vector at each element, the gradient in question is calculated on the basis of magnetization vectors at some other elements adjacent to the selected element, as discussed in FIG. 9A. When the original result dataset gives magnetization vectors at each element, the gradient in question is calculated on the basis of magnetization vectors at the nodes forming the vertices of the selected element, as discussed in FIG. 9B.

(S18) For each grid point found at step S16 as being contained in the selected element, the data compression unit 124 identifies the layer to which the grid point belong, as well as the grid coordinates (Xn, Yn, Zn) of the grid point. The layer identified at this step S18 is referred to as Layer-N.

(S19) The data compression unit 124 determines whether the gradient calculated at step S17 exceeds the Layer-N threshold Gn. If the gradient exceeds the threshold Gn, the process advances to step S20. If the gradient is smaller than or equal to the threshold Gn, the process skips to step S21.

(S20) The data compression unit 124 calculates a magnetization vector corresponding to each grid point contained in the selected element. When the original result dataset gives a magnetization vector at each element, the magnetization vector at a grid point is calculated on the basis of the magnetization vector at COG of the element and a position vector drawn from the COG to the grid point in question, as discussed in FIG. 10A. When the original result dataset gives magnetization vectors at each node, the magnetization vector at a grid point is calculated on the basis of magnetization vectors at the nodes that form the vertices of the selected element, as discussed in FIG. 10B. The data compression unit 124 then produces a new record(s) for the result file 134 which associates the calculated magnetization vector (Mx, My, Mz) of each grid point with the grid coordinates (Xn, Yn, Zn) of the same.

(S21) The data compression unit 124 determines whether step S15 has selected all elements in the model. When there are no pending elements, this process of data compression is terminated. When there are pending elements, the process goes back to step S15.

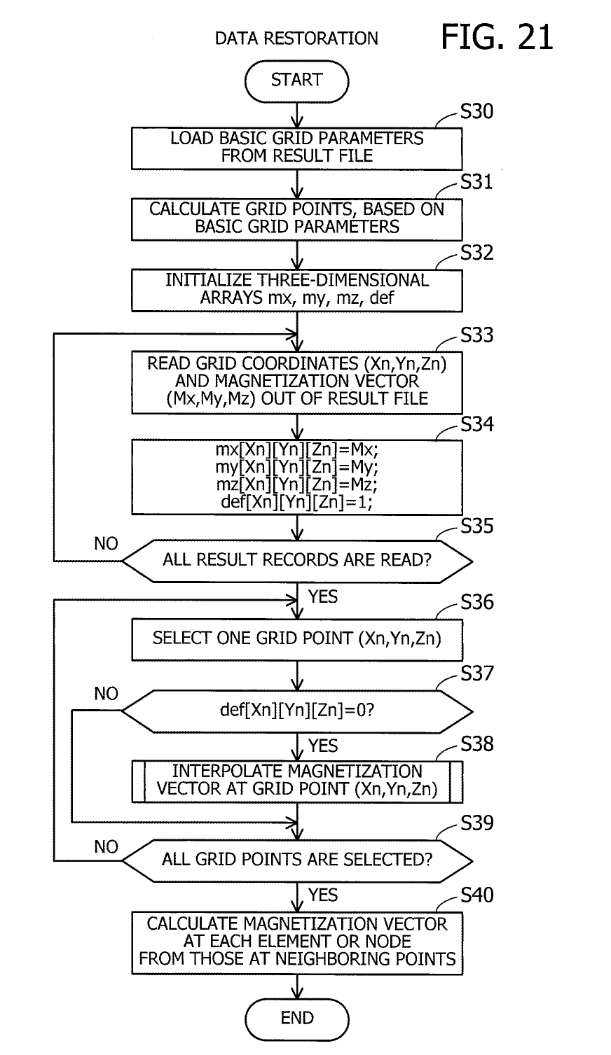

FIG. 21 is a flowchart illustrating an exemplary procedure of data restoration.

(S30) The data restoration unit 125 loads basic grid parameters from a result file 134 stored in the data storage unit 122. The basic grid parameters specifies the following values: maximum layer depth (Nd), size (Sx, Sy, Sz), minimum point coordinates (x0, y0, z0), and subdivision numbers (nx1, ny1, nz1).

(S31) Based on the basic grid parameters, the data restoration unit 125 calculates the coordinates of grid points, from those in Layer-1 to those in Layer-Nd. The resulting grid points are identical to those obtained at step S14, so that the grid points used for data compression are reproduced. Each grid point thus belongs to either of the Nd layers.

(S32) The data restoration unit 125 defines three-dimensional arrays mx, my, mz, and def. These three-dimensional arrays are indexed by three-dimensional grid coordinates. More specifically, array mx contains the X-axis component of each magnetization vector. Array my contains the Y-axis component of each magnetization vector. Array mz contains the Z-axis component of each magnetization vector. Array def contains a flag that indicates whether a magnetization vector is present at each grid point. The data restoration unit 125 initializes every array element of def to zero. In the case of a two-dimensional model, the data restoration unit 125 defines arrays mx, my, and def as two-dimensional arrays.

(S33) The data restoration unit 125 reads one combination of grid coordinates (Xn, Yn, Zn) and a magnetization vector (Mx, My, Mz) out of the result file 134.

(S34) The data restoration unit 125 enters Mx to mx[Xn][Yn][Zn], My to my[Xn][Yn][Zn], Mz to mz[Xn][Yn][Zn], and a value of one to def[Xn][Yn][Zn].

(S35) The data restoration unit 125 determines whether step S33 has read all result records out of the result file 134. When all result records have been read, the process advances to step S36. When more records are present, the process goes back to step S33.

(S36) The data restoration unit 125 selects one grid point.

(S37) The data restoration unit 125 determines whether the grid point selected at step S36 satisfies def[Xn][Yn][Zn]=0. In other words, it is tested whether the result file 134 contains no record of magnetization vector at grid coordinates (Xn, Yn, Zn). If no magnetization vector is present, the process advances to step S38. Otherwise, the process skips to step S39.

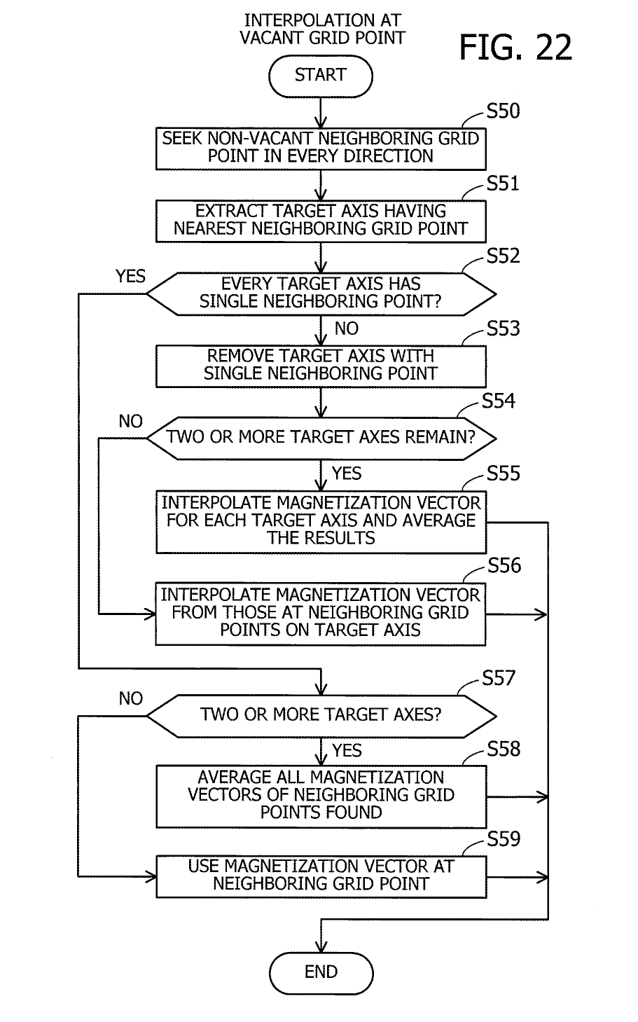

(S38) The data restoration unit 125 interpolates the missing magnetization vector at the selected grid point (Xn, Yn, Zn) on the basis of magnetization vectors at other grid points surrounding the selected grid point. The detailed procedure of this step will be described later (FIG. 22).

(S39) The data restoration unit 125 determines whether step S36 has selected all grid points. When all grid points have been selected, the process advances to step S40. When pending grid points are present, the process goes back to step S36.

(S40) The data restoration unit 125 calculates a magnetization vector at each element or node of the model from magnetization vectors at neighboring grid points around the element or node in question by using the Lagrange interpolation method or the like. For example, the data restoration unit 125 calculates a magnetization vector at COG of an element from magnetization vectors at four or eight grid points that form the vertices of a grid cell containing COG of the element in question. Alternatively, the data restoration unit 125 calculates a magnetization vector at a node from magnetization vectors at four or eight grid points that form the vertices of a grid cell containing the node in question. The choice between elements and nodes may be specified by the user.

FIG. 22 is a flowchart illustrating an exemplary procedure of interpolation at a vacant grid point. This interpolation is what is executed at step S38 briefly described above.

(S50) The data restoration unit 125 seeks neighboring grid points from the selected vacant grid point in both the positive and negative directions of each axis (e.g., each of the X, Y, Z coordinate axes), where the term “neighboring grid point” refers to a non-vacant grid point (i.e., grid point having a known magnetization vector) that is located in the vicinity of the selected grid point. In this grid point search, the data restoration unit 125 chooses at most one grid point for each combination of an axis and a direction (positive or negative) that is closest to the selected grid point.

(S51) The data restoration unit 125 extracts one or more nearest neighboring grid points out of the set of neighboring grid points found at step S50, where grid points are qualified as “nearest” when they have a longer distance (or a greater number of hops) from the selected grid point than any other neighboring grid points. The data restoration unit 125 further extracts some of the coordinate axes (e.g., X, Y, Z axes) that have at least one nearest neighboring grid points. The extracted axis (axes) is referred to as a target axis (axes).

(S52) The target axes extracted at step S51 may be divided into two groups: those having a pair of neighboring grid points, one in the positive direction and the other in the negative direction relative to the selected grid point, and those having only one neighboring grid point in either the positive or the negative direction (i.e., there is no known magnetization vector in the other direction). The data restoration unit 125 determines whether every extracted target axis belongs to the latter group. If this condition is true, the process skips to step S57. If this condition is false, the process advances to step S53.

(S53) The data restoration unit 125 removes the latter group of target axes from the set of target axes extracted at step S51.

(S54) The data restoration unit 125 counts the number of remaining target axes. When two or more target axes remain, the process advances to step S55. When there remains only one target axis, the process skips to step S56.

(S55) For each specific target axis, the data restoration unit 125 interpolates a magnetization vector at the selected grid point by using known magnetization vectors at the positive-negative pair of neighboring grid points. The interpolation is a simple average of the two magnetization vectors when the positive-negative pair of neighboring grid points are equally distant from the selected grid point. When the two neighboring grid points have different distances, the interpolation will be a weighted average of their magnetization vectors, the weights being determined from the distances. Now that two or more interpolated values of magnetization vectors are obtained, the data restoration unit 125 averages them together, thus finalizing the magnetization vector at the selected grid point.

(S56) The data restoration unit 125 interpolates a missing magnetization vector at the selected grid point by using known magnetization vectors at the positive-negative pair of neighboring grid points on the single remaining target axis.

(S57) The data restoration unit 125 determines whether two or more target axes are present. When two or more target axes are present, the process advances to step S58. When only one target axis is present, the process proceeds to step S59.

(S58) The data restoration unit 125 averages all magnetization vectors of the neighboring grid points that have been found at step S50, thus obtaining the missing magnetization vector at the selected grid point.

(S59) The data restoration unit 125 uses the magnetization vector of the single neighboring point found at step S50 as a magnetization vector at the selected grid point.

According to the information processing system of the second embodiment described above, an FEM analysis is performed on a model, and the calculated magnetization vectors at elements or nodes of the model are provided in a result dataset. The result dataset is then transformed to a collection of magnetization vectors at grid points in a Cartesian coordinate system. The magnetization vectors at grid points are stored in a storage device, instead of the original magnetization vectors at elements or nodes. It is easier to subsample magnetization vectors from those of regularly arranged grid points, than from those of irregularly arranged elements or nodes. The subsampling of magnetization vectors in small-gradient regions of the model is particularly effective at reducing the volume of result data without sacrificing the accuracy of the data.

The use of the above-described data compression before storing a result dataset saves storage resources in the system. The same data compression may also be advantageous when sending a result dataset over a network 20, because it reduces consumption of network bandwidths besides cutting the total time of communication. At the time of reading a compressed result file from a storage device, missing magnetization vectors of vacant grid points are interpolated from those of surrounding grid points. Magnetization vectors at elements or nodes of the model are then restored on the basis of magnetization vectors at grid points, which reproduces the original set of magnetization vectors obtained as result data of an FEM analysis.

The process of information processing discussed above in the first embodiment may be realized by causing a finite element computing apparatus 10 to execute a program coded therefor. Likewise, the process of information processing discussed above in the second embodiment may be realized by causing computational nodes 21 to 27 or an analyzer apparatus 100 to execute a program coded therefor.

These programs may be stored in a non-transitory computer-readable medium such as a storage medium 113 discussed in FIG. 3. For example, the suitable storage media for this purpose include, but are not limited to magnetic disks, optical discs, magneto-optical discs, and semiconductor memory devices. More specifically, magnetic disk media include FD and HDD. Optical disc media include CD, CD-Recordable (CD-R), CD-Rewritable (CD-RW), DVD, DVD recordable (DVD-R), and DVD rewritable (DVD-RW). A program may be distributed in the form of portable storage media. The program encoded in a portable storage medium may be executed after being copied to some other storage medium (e.g., HDD 103).

Several embodiments and their variations have been described above. In one aspect of at least one those embodiments, the proposed techniques reduce the amount of result data of an FEM analysis.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A non-transitory computer-readable medium storing a program that causes a computer to perform a procedure comprising:
obtaining a first dataset including first values calculated for a model that includes a plurality of nodes and a plurality of elements each being a region whose boundaries are defined by three or more of the nodes, the first values corresponding respectively to the plurality of nodes or elements;
calculating a plurality of grid points addressed by coordinates of two or more orthogonal axes;
calculating second values corresponding respectively to a subset of the grid points, based on positions of the nodes or elements and the first values included in the first dataset;
storing a second dataset including the second values into a storage device; and
restoring, when the second dataset is read out of the storage device, the first values corresponding respectively to the plurality of nodes or elements, based on positions of the subset of the grid points and the second values included in the second dataset.

2. The non-transitory computer-readable medium according to claim 1, wherein the storing the second dataset includes:
calculating a gradient that the first values exhibit at an element containing one of the grid points; and
determining whether to include in the second dataset the second value corresponding to the one of the grid points, depending on a comparison between the calculated gradient and a threshold.

3. The non-transitory computer-readable medium according to claim 2, wherein:
the plurality of grid points are classified into a plurality of different levels;
a plurality of threshold values are associated respectively with the plurality of levels; and
the threshold compared with the gradient of the first values is one of the threshold values that is associated with the level to which the one of the grid points belongs.

4. The non-transitory computer-readable medium according to claim 2, wherein the restoring the first values includes:
interpolating, upon detection of a grid point whose corresponding second values is missing in the second dataset, the missing second value by using the second values corresponding to neighboring grid points around the detected grid point.

5. The non-transitory computer-readable medium according to claim 1, wherein the grid points are fewer than the elements or nodes of the model.

6. An apparatus for performing finite element computation, comprising:
a storage device; and
a processor configured to perform a procedure including:
obtaining a first dataset including first values calculated for a model that includes a plurality of nodes and a plurality of elements each being a region whose boundaries are defined by three or more of the nodes, the first values corresponding respectively to the plurality of nodes or elements;
calculating a plurality of grid points addressed by coordinates of two or more orthogonal axes;
calculating second values corresponding respectively to a subset of the grid points, based on positions of the nodes or elements and the first values included in the first dataset;
storing a second dataset including the second values into the storage device; and
restoring, when the second dataset is read out of the storage device, the first values corresponding respectively to the plurality of nodes or elements, based on positions of the subset of the grid points and the second values included in the second dataset.

7. A method for performing finite element computation, comprising:
obtaining, by a processor, a first dataset including first values calculated for a model that includes a plurality of nodes and a plurality of elements each being a region whose boundaries are defined by three or more of the nodes, the first values corresponding respectively to the plurality of nodes or elements;
calculating, by the processor, a plurality of grid points addressed by coordinates of two or more orthogonal axes;
calculating, by the processor, second values corresponding respectively to a subset of the grid points, based on positions of the nodes or elements and the first values included in the first dataset;
storing, by the processor, a second dataset including the second values into the storage device; and
restoring, by the processor when the second dataset is read out of the storage device, the first values corresponding respectively to the plurality of nodes or elements, based on positions of the subset of the grid points and the second values included in the second dataset.
